(19) United States
(12) Patent Application Publication
(10) Pub. No.: US 2006/0185499 A1
(43) Pub. Date: Aug. 24, 2006

(54) Optical display interface for electronic tuner for musical instruments

(76) Inventors: James A. D'Addario, Old Westbury, NY (US); Henry B. Wallace, Fincastle, VA (US)

Correspondence Address: BODNER & O'ROURKE, LLP, 425 BROADHOLLOW ROAD, SUITE 108, MELVILLE, NY, 11747, US

(21) Appl. No.: 11/336,654

(22) Filed: Jan. 20, 2006

Related U.S. Application Data
(60) Provisional application No. 60/645,671, filed on Jan. 21, 2005.

(51) Int. Cl. G10G 7/02

(52) U.S. Cl. 84/454

(57) ABSTRACT

A display interface for an electronic tuner for tuning a musical instrument includes a plurality of spaced apart, separately illuminatable, light emitting diodes (LEDs) situated in a continuous circular array. A cylindrically-shaped light pipe is situated in proximity to the circular array of LEDs. The light pipe has radially extending slits formed therein to define individually illuminatable segments. Each segment of the light pipe is illuminatable by a respective light emitting device. A disc-shaped note dial is situated in proximity to the light pipe and has illuminatable indicia on a surface thereof corresponding to musical notes. The indicia is illuminatable by the light pipe for viewing by a user of the electronic tuner.

### CROSS REFERENCE TO RELATED APPLICATION

This application is related to U.S. provisional patent application Ser. No. 60/645,671, filed on Jan. 21, 2005, and entitled “Optical Display Interface For Electronic Tuner For Musical Instruments”, the disclosure of which is incorporated herein by reference. This application claims the benefit of priority under 35 U.S.C. 119 to the aforementioned related provisional application.

### BACKGROUND OF THE INVENTION

1. Field of the Invention

The present invention generally relates to tuners for musical instruments, and more particularly relates to an interface for an electronic tuner for musical instruments to optically display for a musical note the pitch detected and the relative intonation of the note.

2. Description of the Prior Art

One of the most basic requirements for a musician is to be sure that his or her musical instrument is “in tune”, meaning that the frequency (or pitch) of the notes produced by the instrument corresponds precisely to that of a known reference.

A correctly tuned instrument, for instance, will produce a 440 hertz (Hz) pitch when an “A” note is played. An in tune “A” note is also produced when this frequency is halved (at 220 Hz), although the A note at 220 Hz will be one octave lower than the A note at 440 Hz. Similarly, A notes of various octaves are produced at 55 Hz, 110 Hz, 880 Hz, etc.

Western music has historically been based upon dividing the range between notes an octave apart into twelve equally spaced pitches, yielding a series of twelve notes: C, C# (also known as Db), D, D# (Eb), E, F, F# (Gb), G, G# (Ab), A, A# (Bb), and B. Each of these notes has a well-defined frequency benchmark. Most instruments are capable of producing an infinite variety of pitches, however, so it is necessary to calibrate and correct the pitch of an instrument so that the notes will be properly tuned relative to these agreed-upon benchmarks.

The function of electronic tuners is to detect, via a microphone or an electrical connection to the transducer (“pick up”) of an electric instrument, the pitch of a note that is produced by an instrument. Once this sound has been detected, the electronic tuner displays the specific note that the pitch most closely corresponds to, along with an indication of how precise the pitch is relative to the correct theoretical frequency for the given note. A pitch produced by a musical instrument that is close to but higher in frequency than a known reference is considered to be “Sharp” (#). For example, an A note at 450 Hz compared to a reference A note at 440 Hz would be considered to be “Sharp,” since the frequency is high relative to the 440 Hz reference. A note at 430 Hz is “Flat”, again, since it is below the 440 Hz reference.

Note that the frequency of a note may be divided into +/−50 cents, indicating the relative degree that the note is flat or sharp; electronic tuners also typically are designed to indicate intonation +/−50 cents.

There are several known electronic tuners on the market today. These include the RT-7 100 Rack Tuner manufactured by Sabine, Inc. of Alachua, Fla., and the Boss TU-2 Chromatic Tuner manufactured by Roland Corporation of Los Angeles, California. These electronic tuners have linear segmented displays and, thus, are not compact in size. Also, such linear displays do not lend themselves well to various tuning display modes, such as a “sweep” mode and a “strobe” mode, as the illumination of the segments is not necessarily continuous at the opposite ends of the display.

### OBJECTS AND SUMMARY OF THE INVENTION

It is an object of this invention to provide an interface for an electronic tuning device for a musical instrument which provides an inexpensive, compact yet easily discernible illuminated dial display which enables a user to readily and quickly determine whether a musical instrument is in tune and to quickly determine the effects of manual tuning adjustment.

The present invention is an interface for an electronic tuning device which provides a compact, portable but easily discernible display having bi-color light emitting diodes (LEDs) which are arranged in a circular pattern as an illuminated dial display. This arrangement enables a user to readily and quickly determine whether a musical instrument is in tune and to quickly determine the effects of manual tuning adjustment. The interface provides either or both of two major modes of operation, which are a sweep mode and a strobe mode, to afford a readily discernible process for the user to determine when the musical instrument has been properly tuned. The modes can be selected by a preferably combined dual function power switch and display mode selector switch. A calibration reference frequency can be easily changed by pressing a reference frequency switch.

More specifically, the present invention is directed to a display interface for an electronic tuner for a musical instrument. The circuitry of the electronic tuner receives an analog signal corresponding to a note played directly from the musical instrument, if it is an electric instrument, or from a microphone, if the instrument is acoustic. The analog signal is amplified by an audio amplifier and then passed to a voltage comparator which digitizes it. The digitized signal, having a frequency corresponding to the note played, is then provided to the input of a microprocessor or microcontroller.

The microcontroller determines the frequency of the note played from the digitized signal and compares the frequency to known reference frequencies in the microcontroller's memory, to determine whether the note played is flat or sharp. The microprocessor controls the illumination of the display interface to indicate to the user the note played and whether it is flat or sharp.

A display interface for connecting to an electronic tuner for tuning a musical instrument, such as described previously, preferably includes a plurality of spaced apart, separately illuminatable, light emitting devices situated in a continuous circular array. A cylindrically-shaped light pipe is situated in proximity to the circular array of light emitting devices. The light pipe includes radially extending slits formed therein to define individually illuminatable segments. Each segment of the light pipe is illuminatable by a respective light emitting device. The display interface further includes a disc-shaped note dial. The note dial is situated in proximity to the light pipe, and includes illuminatable indicia on a surface thereof corresponding to musical notes. The indicia is illuminatable by the light pipe for viewing by a user of the electronic tuner. The microprocessor or microcontroller of the electronic tuner is operatively coupled to the display interface and selectively illuminates the light emitting devices.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a block diagram of the electrical circuit of an in-line electronic tuner formed in accordance with the present invention for tuning a musical instrument.

FIG. 2 is a front view of a preferred form of a display interface formed in accordance with the present invention for use with the electronic tuner of FIG. 1.

FIG. 3 is an exploded front isometric view of the in-line tuner of the present invention and illustrating the preferred components of the display interface of the present invention used therein.

FIG. 4 is an exploded rear isometric view of the in-line tuner of the present invention, with the preferred components of the display interface shown therein.

FIG. 4A is a rear isometric view of a component of the display interface of the present invention.

FIG. 4B is a front isometric view of the component shown in FIG. 4A.

FIG. 5 is an elevation view of the in-line electronic tuner incorporating the display interface of the present invention.

FIG. 6A is an enlarged front view of the display interface of the present invention illustrating its operation in a sweep mode with respect to a first reference note played on a musical instrument.

FIG. 6B is an enlarged front view of the display interface of the present invention shown in FIG. 6A illustrating when the frequency of a played note has been tuned to correspond to the frequency of the first reference note.

FIG. 7A is an enlarged front view of the display interface of the present invention illustrating its operation in a sweep mode with respect to a second reference note played on a musical instrument which differs from the first reference note illustrated in FIG. 6A.

FIG. 7B is an enlarged front view of the display interface of the present invention shown in FIG. 7A when the frequency of a played note has been tuned to correspond to that of the second reference note.

FIG. 8A is an enlarged front view of the display interface of the present invention illustrating its operation in a strobe mode and when a played note is sharp relative to a reference note.

FIG. 8B is an enlarged front view of the display interface of the present invention illustrating its operation in a strobe mode and when a played note is flat relative to a reference note.

FIG. 8C is an enlarged front view of the display interface of the present invention shown in FIGS. 8A and 8B in a strobe mode of operation when the frequency of the played note has been tuned to correspond to that of the reference note.

FIG. 9 is an enlarged front view of the display interface of the present invention illustrating the display interface when the electronic tuner associated therewith is powering down.

FIG. 10 is an enlarged rear view of a portion of the housing of an in-line electronic tuner illustrating a calibration reference frequency chart.

FIG. 11 is an enlarged front view of the display interface of the present invention when a reference pitch selector switch is pressed once.

FIG. 12 is an enlarged front view of the display interface of the present invention shown in FIG. 11 when the reference pitch selector switch is pressed twice.

FIG. 13 is an enlarged front view of the display interface of the present invention shown in FIG. 12 when the reference pitch selector switch is pressed thrice.

FIG. 14 is an operational flowchart of the microcontroller of the electronic tuner for operation of the tuner in the sweep mode.

FIG. 15 is an operational flowchart of the microcontroller of the electronic tuner for operation of the tuner in the strobe mode.

FIG. 16 is an operational flowchart of the microcontroller of the electronic tuner for operation of the tuner in the reference frequency selection mode.

FIG. 17 is an exploded perspective view of another form of a display interface of the present invention for an electronic tuner.

FIG. 18 is a rear isometric view of a display cover forming part of the display interface of the present invention shown in FIG. 17.

FIG. 19 is a front isometric view of the display cover shown in FIG. 18.

FIG. 20 is a rear plan view of a lens forming part of the display interface of the present invention shown in FIG. 17.

FIG. 21 is a front plan view of the lens shown in FIG. 20.

FIG. 22 is a side view of the lens shown in FIGS. 20 and 21.

### DETAILED DESCRIPTION OF THE PREFERRED EMBODIMENTS

The present invention is directed to an interface for an electronic tuning device for a musical instrument which provides an inexpensive, compact yet easily discernible illuminated dial display that enables a user to readily and quickly determine whether a musical instrument is in tune and to quickly determine the effects of manual tuning adjustment.

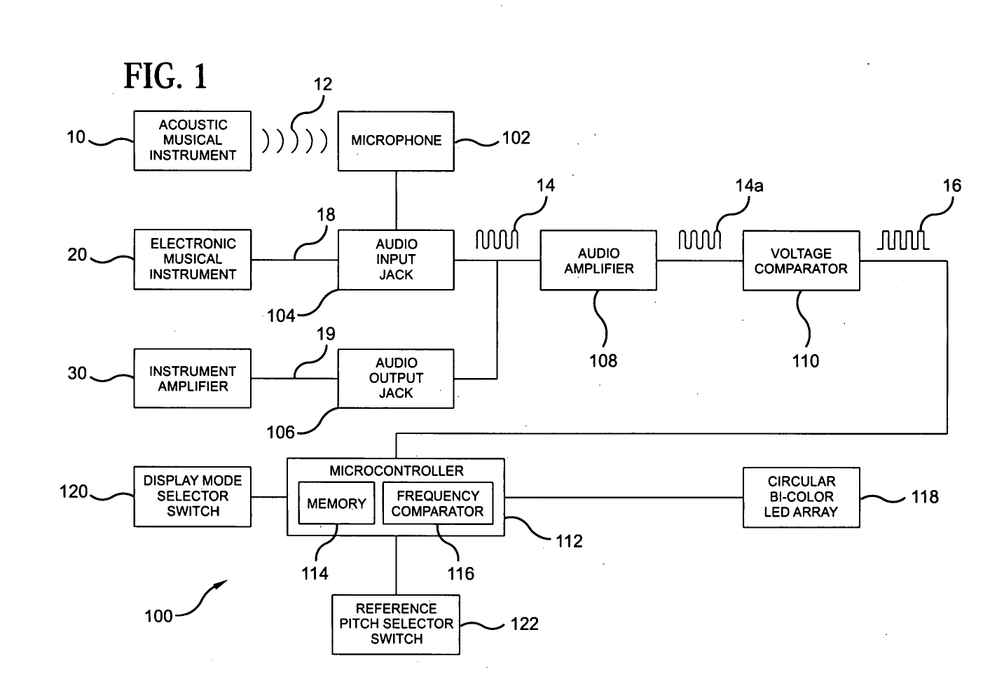

FIG. 1 is a block diagram of a circuit 100 of an electronic tuner for tuning a musical instrument, which circuit controls the illumination of a display interface connected thereto. The circuit 100 may be used to tune either an acoustic musical instrument 10, such as an acoustic guitar, or an electronic musical instrument 20, such as an electric guitar. When the instrument to be tuned is an acoustic musical instrument 10, a microphone 102, preferably internal to the electronic tuner, receives acoustic waves 12 from the acoustic instrument 10. The microphone 102 acts as a transducer, converting the acoustic waves 12 to an output electrical analog signal 14 having a frequency which corresponds to that of the musical note played on the instrument. When the instrument to be tuned is an electronic musical instrument 20, such as an electric guitar, the instrument is plugged into an audio input jack 104 via a cable (and mating plug) 18, which automatically disconnects microphone 102. The electronic instrument 20 provides an electrical analog signal 14 to the circuit 100, which signal corresponds in frequency to a particular musical note played.

The electronic tuning device is preferably an in-line tuner, in that it may be placed in series between the electronic musical instrument 20 and an instrument amplifier 30. When the tuner is used in this manner, an electrical cable (and mating plug) 18 from the instrument 20 is connected the audio input jack 104, and another cable (and mating plug) 19 connected to the instrument amplifier 30 is coupled to an audio output jack 106. Thus, the electric signal 14 from the instrument passes through the in-line tuner to the instrument amplifier 30, with a sample of the signal being taken by the tuner circuit 100 for measurement purposes. In a foot pedal operated embodiment of the electronic tuner, a foot pedal switch (not shown) selectively breaks the electrical connection between the musical instrument 20 and the instrument amplifier 30 so that just the electronic tuner is connected to the musical instrument, and thus the musician's efforts in tuning the instrument are not amplified and heard by others, such as an audience at a performance.

The circuit 100 of the electronic tuner further includes an audio amplifier 108 which receives the electric signal 14 and amplifies it, thereby generating amplified analog signal 14a. The amplified analog signal 14a is provided to a voltage comparator 110, which clips the amplified analog signal 14a and converts it to a digital logic electrical signal 16, so that it is compatible for operation with the remaining digital components of the tuner circuit. A microcontroller or microprocessor 112 is coupled to the voltage comparator 110 and receives the digitized electrical signal 16. The microcontroller 112 includes, either internally or externally, a storage memory 114, which stores the frequencies corresponding to twelve musical notes, e.g., the fundamental frequencies for notes A, A#/(Bb), B, C, C#/(Db), D, D#/(Eb), E, F, F#/(Gb), G and G#/(Ab). Microcontroller 112 also includes, either internally or externally, a frequency comparator 116. The microcontroller 112 determines by means of the frequency comparator 116 which of the fundamental frequencies corresponding to the musical notes stored in the storage memory 114 the electrical signal 16 most closely equals. The display interface of the present invention, in the form of an optical display, comprised preferably of a circular array of circumferentially spaced apart bi-color light emitting diodes (LEDs) 118, is connected to and driven by the microcontroller 112. Each of the LEDs 118 represents one of the fundamental frequencies of the musical notes mentioned previously. The tuner circuit 100 also includes a display mode selector switch 120 and a reference pitch selector switch 122, each of which is operatively coupled to the microcontroller 112. The function and operation of these switches 120 and 122 will be discussed in greater detail.

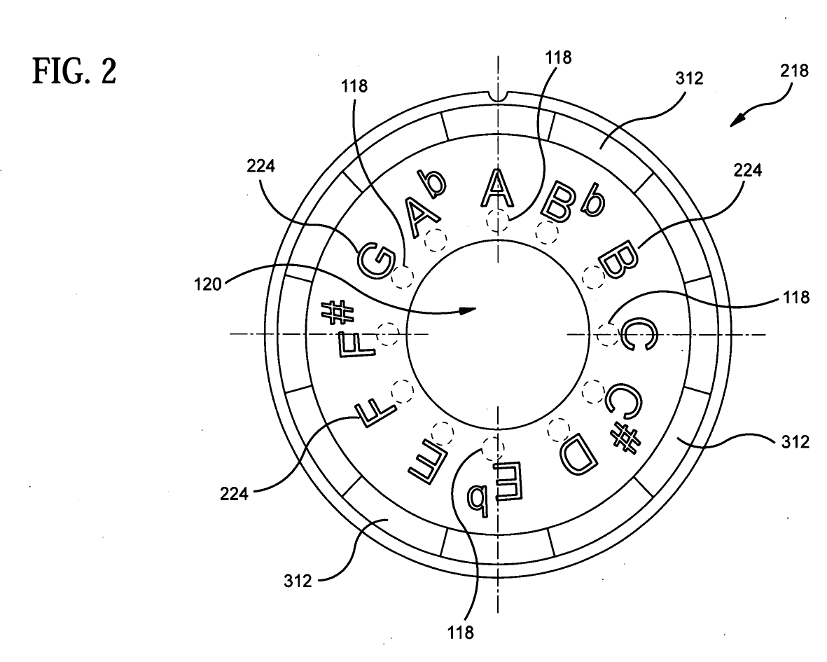

FIG. 2 illustrates a preferred form of the display interface of the present invention, having a note dial 218, illuminated by the circular array of bi-color LEDs 118 described previously. The note dial 218 displays characters 224 representing twelve musical notes: A, A#/(Bb), B, C, C#/(Db),D, D#/(Eb), E, F, F#/(Gb), G and G#/(Ab). Preferably, the notes are circularly arranged in a manner like the dial of a clock so that note A is at the 12 o'clock position, note C is at the 3 o'clock position, note Eb is at the 6 o'clock position, and note F# is at the 9 o'clock position. The display mode selector switch 120, which also functions as a power on/off switch, is preferably disposed at the center of the note dial 218. Of course, it is envisioned that a separate power switch may be included, if desired. In addition, viewable at the outer circumference of the note dial 218 is preferably an array of transparent, illuminatable segments 312 that are circularly arranged radially outwardly of the characters 224. As will be evident from a further description of the preferred components of the display interface, these segments 312 are viewable portions of a light pipe 308 situated behind the note dial 218. Preferably, the LEDs 118 are disposed behind the musical note characters 224 and the transparent segments 312. Thus, each of the musical note characters 224 and the transparent segments 312 is illuminated simultaneously by a respective LED situated behind them.

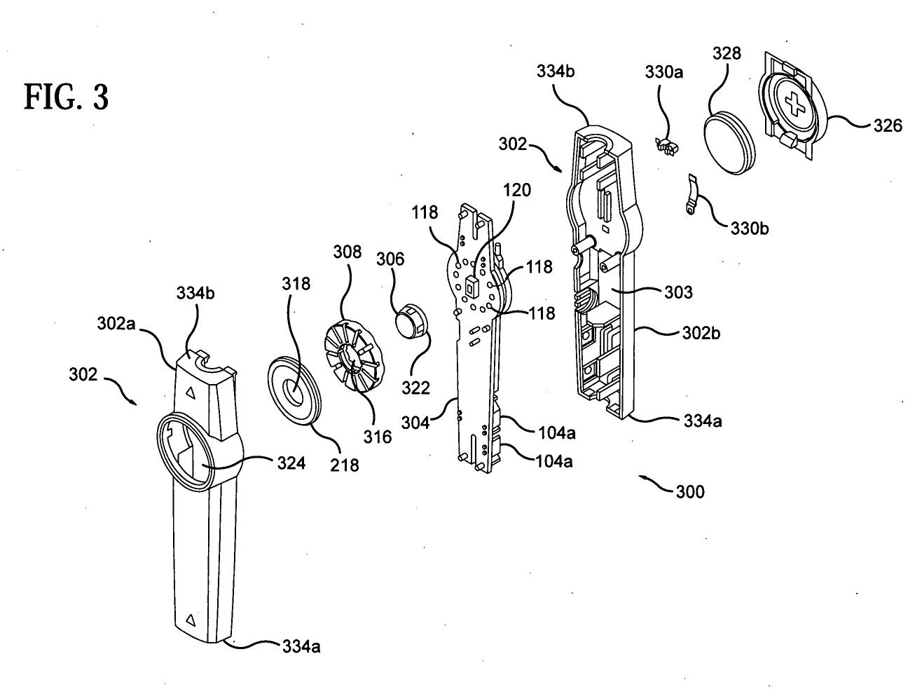

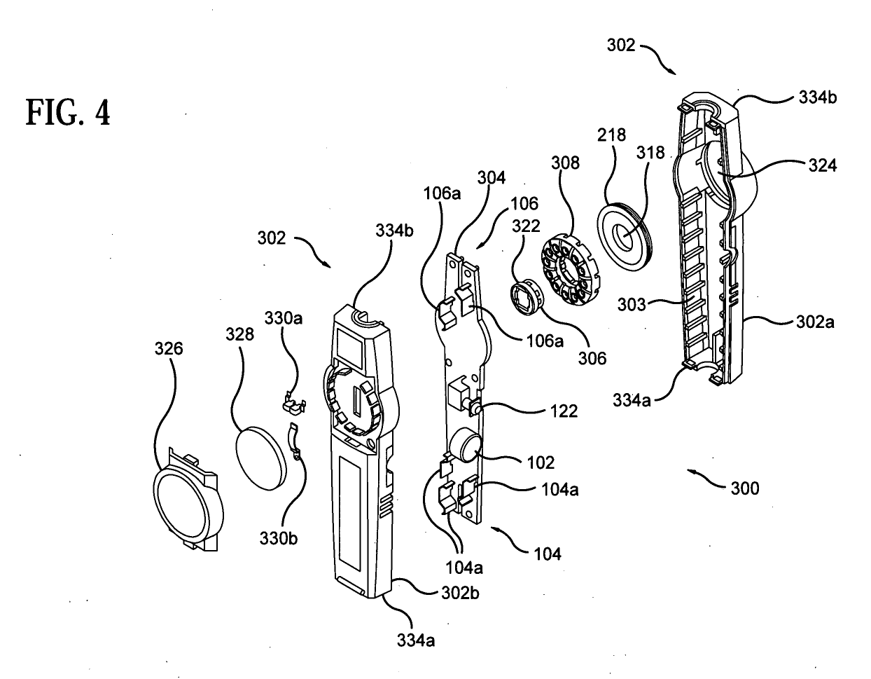

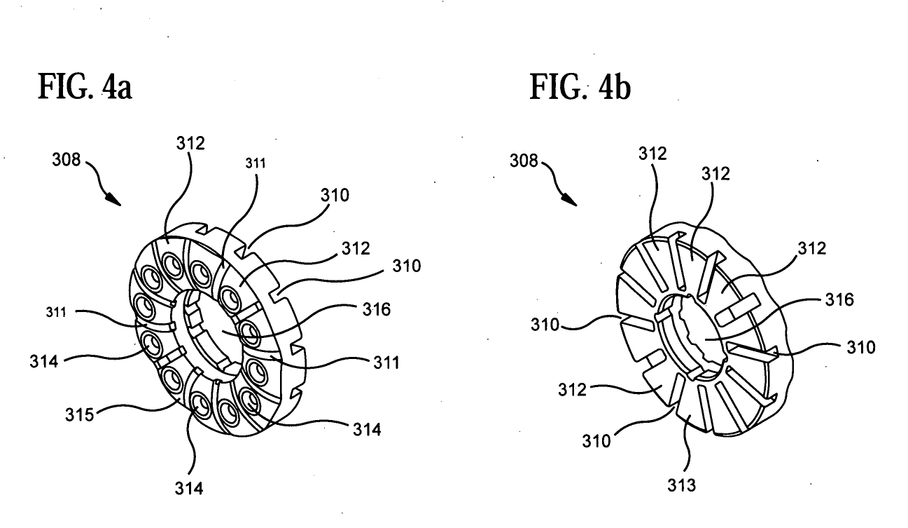

The exploded front and rear isometric views of a preferred form of an in-line electronic tuner 300 shown in FIGS. 3 and 4, respectively, illustrate one form of the display interface of the present invention. The housing 302 of the tuner is formed in two mateable half sections 302a and 302b. The housing 302 defines an interior chamber 303 in which is situated a printed circuit board 304 on which is mounted the tuner circuit 100. One side of the printed circuit board 304 has mounted on it a plurality of spaced apart LEDs 118 situated in a circular array. Centrally situated in the LED array 118 is a momentary pushbutton microswitch, which functions as the display mode selector switch 120 and, preferably, the on/off switch. A pushbutton cap 306 is affixed to the microswitch 120, which pushbutton cap 306 is accessible by the user of the tuner to change tuner modes or to turn on or shut off the tuner 300.

A cylindrically-shaped light pipe 308, having radially extending slits 310, 311, formed in its front surface 313 and rear surface 315, respectively, to define twelve individually illuminatable segments 312 (see also FIGS. 4A and 4B), is situated adjacent to the circular array of LEDs 118. The rear surface 315 of the light pipe 308 has further formed therein recesses or openings 314, one opening 314 situated within each segment 312, to receive the LEDs 118. Accordingly, when any given LED 118 illuminates, the corresponding segment 312 of the light pipe 308 is illuminated thereby.

The disc-shaped note dial 218 is situated concentrically over the front surface 313 of the light pipe 308. The note dial 218 has a smaller diameter than that of the light pipe so that only the outer portions of segments 312 not blocked by the note dial are viewable to the user. As mentioned previously, the note dial 218 has imprinted on the surface thereof indicia in the form of the twelve musical notes 224 of one octave. The note dial is preferably opaque, except for the note indicia 224. Each note indicia 224 is situated in alignment with one corresponding segment 312 of the light pipe 308 so that the note indicia 224 appears as being backlit and readable by a user when a corresponding LED 118 illuminates.

Each of the light pipe 308 and the note dial 218 has formed centrally through the thickness thereof an opening 316, 318, respectively, to receive the pushbutton cap 306 of switch 120. The pushbutton cap 306 includes a radially extending flange 322 so that it is held captive within the tuner housing 302 by the light pipe 308 and note dial 218, but moveable within the openings 316, 318 so that it may be pressed by a user to activate switch 120.

The note dial 218 is aligned with an opening 324 formed in the front half 302a of the housing 302. The diameter of the opening 324 is slightly smaller than that of the note dial 218 so that the note dial 218 is held captive within the interior chamber 303 of the housing 302.

The back half 302b of the housing 302 has a removable cap 326 mounted thereon which houses a disc or watch battery 328. Edge and surface contacts 330a, 330b engage the opposite poles of the battery 328 to provide power to the tuner circuit 100. The microphone 102, for acoustic operation, and the reference pitch selector switch 122 are mounted on the printed circuit board 304, as shown in FIG. 4. The audio input jack 104, formed of resilient leaf contacts 104a, and the audio output jack 106, also formed of resilient leaf contacts 106a, are mounted to the printed circuit board 304 and situated at opposite longitudinal axial ends 334a, 334b of the tuner housing 302.

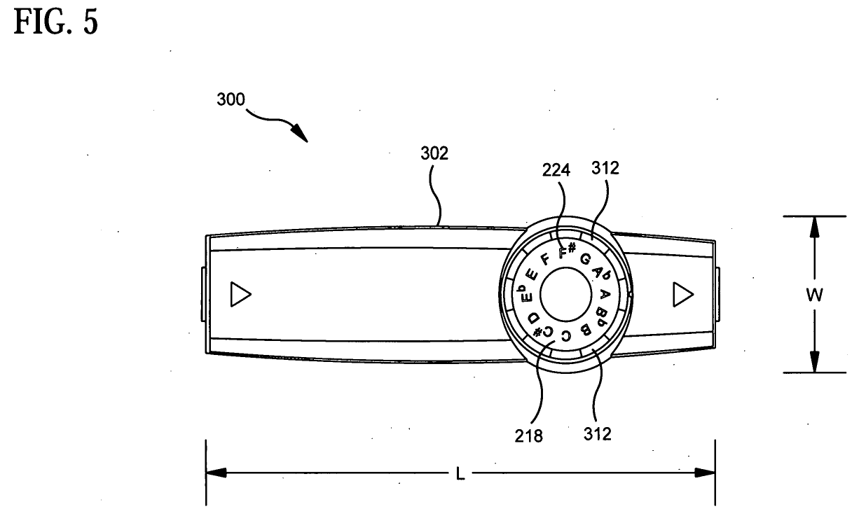

FIG. 5 is a front view of the in-line electronic tuner 300 incorporating the display interface of the present invention. The note dial 218 is disposed on the front half 302a of housing 302 with the bi-color LED array 118 and light pipe 308 situated behind it to illuminate the musical note indicia 224 displayed thereon. The housing 302 is a generally columnar member having preferably a substantially square cross-section with slightly rounded corners and having a rear half 302b. As stated previously, the electronic components including the microphone 102, the audio amplifier 108, the voltage comparator 110 and the microprocessor or microcontroller 112 are all enclosed within the housing 302. To illustrate the compactness of the housing 302, as shown in FIG. 5, the length L of the housing is preferably about 3.9 in. (98.6 mm), the width W of the housing is preferably about 0.75 in. (19.2 mm) and the depth is preferably about 0.67 in. (17.1 mm).

As noted previously, preferably, the display mode selector switch 120 functions also as a power switch. The display mode selector switch 120 enables the user to select by pressing the switch in a consecutive manner a sweep mode, a strobe mode, and a power off mode of operation.

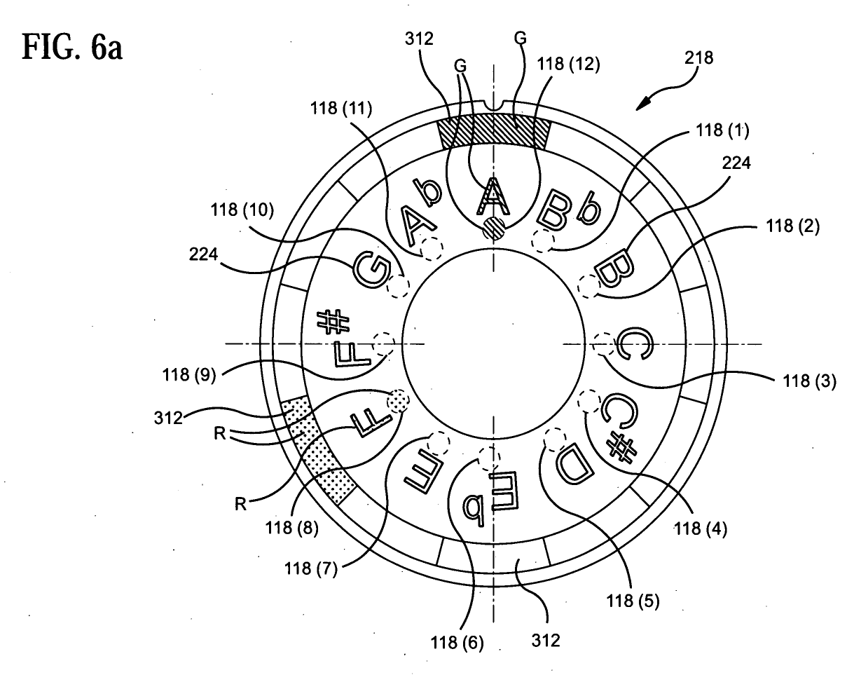

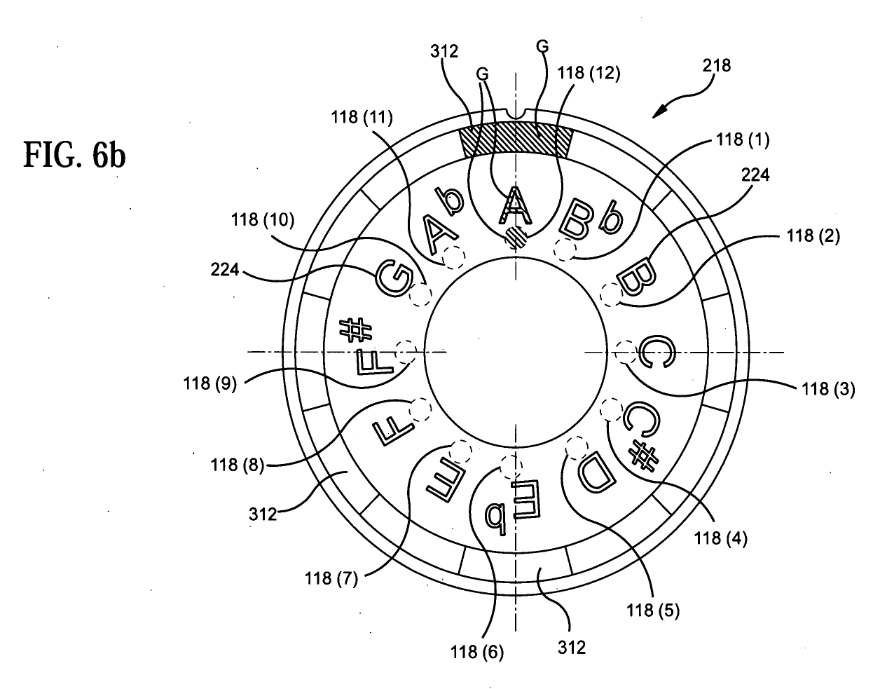

Referring now to FIG. 6A of the drawings, it will be seen that, in the sweep mode of operation, the LED 118 corresponding to the note played lights up in one color, for example, green, designated by the letter G. An LED 118 in a different color, for example, red, designated by the letter R, will appear counter-clockwise of the green LED 118 if the note played is flat, and clockwise of the green LED 118 if the note is sharp. When only the green LED 118 is lit, the instrument 10 or 20 is in tune with respect to that note played.

More specifically, when the mode switch 120 is pressed once, the tuner 300 preferably goes into the sweep mode of operation. This sweep mode is indicated to the user by the microcontroller 112 causing adjacent LEDs 118 to sequentially illuminate in red partially about the note dial 218, alternately on each side of the note A, LED 118(12) (illuminated in green), a few times, in a sweeping fashion. The LED 118(12) associated with the note played lights up in green. If the note played is flat, a red LED, such as LED 118(7), 118(8), 118(9), 118(10) or 118(11), counter-clockwise of the green note LED 118(12), will light. If the note played is sharp, a red LED, such as LED 118(5), 118(4), 118(3), 118(2) or 118(1), clockwise of the green note LED 118(12), will light. The particular red LED 118 that lights (i.e., how far clockwise or counter-clockwise from the green LED) indicates proportionally how flat or sharp the note is. The user tunes the instrument so that the red illuminated LED moves toward the green LED. When only the green LED remains lit, the musical instrument is in tune.

Again referring to FIG. 6A, when a user presses switch 120, power is turned on and the tuner circuit 100 enters into the sweep mode of operation as part of the display mode selection process. Assuming that the user wishes to tune musical note A of the musical instrument 10 or 20, the microprocessor or microcontroller 112 receives the digitized electrical signal 16 corresponding in frequency to the note played on acoustic musical instrument 10 or the electronic musical instrument 20. By means of frequency comparator 116, the microcontroller 112 compares the frequency of the electrical signal 16 to the fundamental frequencies of the musical notes stored in the storage memory 114 and determines which one of the musical notes is being tuned. The microcontroller 112 then illuminates LED 118(12), corresponding to reference musical note A at the 12 o'clock position on the note dial 218, in a particular color, preferably green. FIG. 6A illustrates LED 118(12), musical note A indicia 224 and segment 312 corresponding thereto as being illuminated in green.

The microcontroller 112 also illuminates one of the plurality of LEDs 118(5), (4), (3), (2) (1), (11), (10), (9), (8), or (7), extending from the 5 o'clock to 12 o'clock (sharp 50 cents) and 7 o'clock to 12 o'clock (flat 50 cents) positions, which are the angular extents of the LEDs that may be lit for tuning the note A, to illuminate in another color, preferably red, with the microcontroller 112 selecting the one of the plurality of LEDs 118(5), (4), (3), (2) (1) or LEDs 118(11), (10), (9), (8), (7), to represent the intonation, i.e., whether the frequency of the note played is flat or sharp. In particular, the microcontroller 112 selects one of the plurality of LEDs (11), (10), (9), (8), or (7), disposed counter-clockwise to the reference musical note A, to represent the played note as being flat, and the microcontroller 112 selects one of the plurality of LEDs 118(5), (4), (3), (2) (1), disposed clockwise to the reference musical note A, to represent the played note as being sharp. FIG. 6A illustrates LED 118(8), musical note F indicia 224 and segment 312 corresponding thereto as being illuminated in red, indicating that the played note is flat with respect to the reference note A.

The microcontroller 112 illuminates the one of the plurality of LEDs 118(5), (4), (3), (2) (1), or LEDs 118(11), (10), (9), (8), or (7), to represent proportionally the difference in the frequency of the played note and the frequency of the reference musical note 224(12). As the user tunes the instrument 10 or 20, the microcontroller 112 will illuminate other LEDs 118 in red that are circumferentially closer to or farther from the illuminated green reference note LED 118(12), depending on how out of tune the musical instrument is.

As a result, each of the LEDs 118(1) through (11) represents a different arcuate distance from the illuminated reference note LED (in green) proportional to a sweep angle Θ with respect to the 12 o'clock position, the red reference LED 118(12) for note A, which is at 0°. That is, the 1 o'clock position represents a sweep angle Θ of +30°, the 2 o'clock position is +60°, the 3 o'clock position is +90°, and so on, with the 12 o'clock position being at 0°. Therefore, the LEDs 118(1) to (11) illuminate at different angular positions on the note dial 218 in accordance with the difference in frequency of the reference note (in this case, A) and the frequency of the played note.

Note that in the example given above for tuning musical note A, the LED 118(6) situated at the 6 o'clock position, corresponding to D #/Eb is never illuminated. The purpose of not illuminating the LED 118(6) diametrically opposite the reference note LED 118(12) is to provide a clear demarcation between those red LEDs 118(7), 118(8), 118(9), 118(10) and 118(11) situated counter-clockwise of the green reference note LED 118(12), which signify that the played note is flat, and those red LEDs 118(1), 118(2), 118(3), 118(4) and 118(5) situated clockwise of the green reference note LED, which signify that the played note is sharp.

As illustrated by FIG. 6B, when the user has tuned his instrument 10 or 20 such that the frequency of the played note corresponds to the frequency of the reference note, all of the red LEDs 118(1) through 118(5) and 118(7) through 118(11) are extinguished by the microcontroller 112, and only the green reference note LED 118(12) remains illuminated.

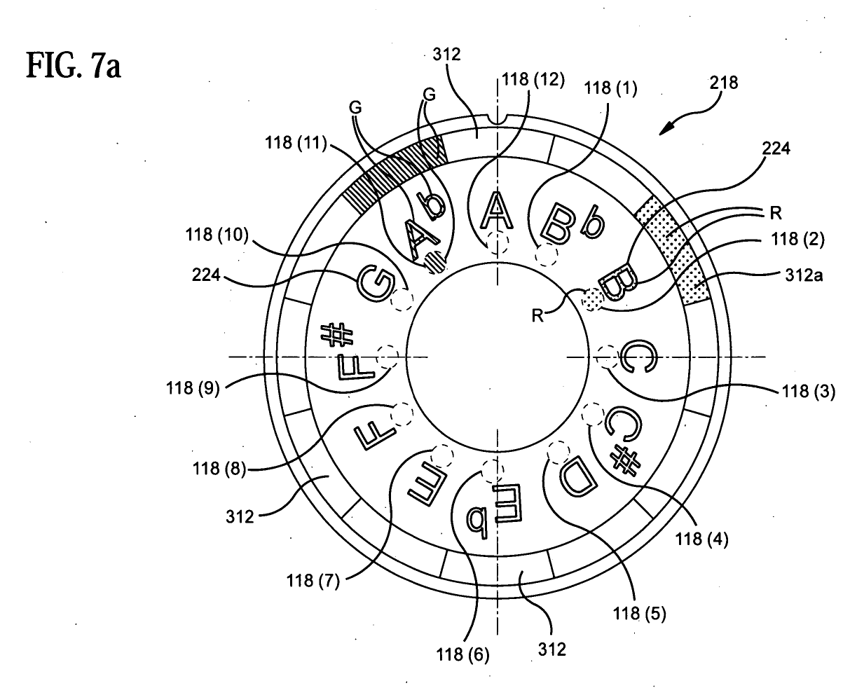

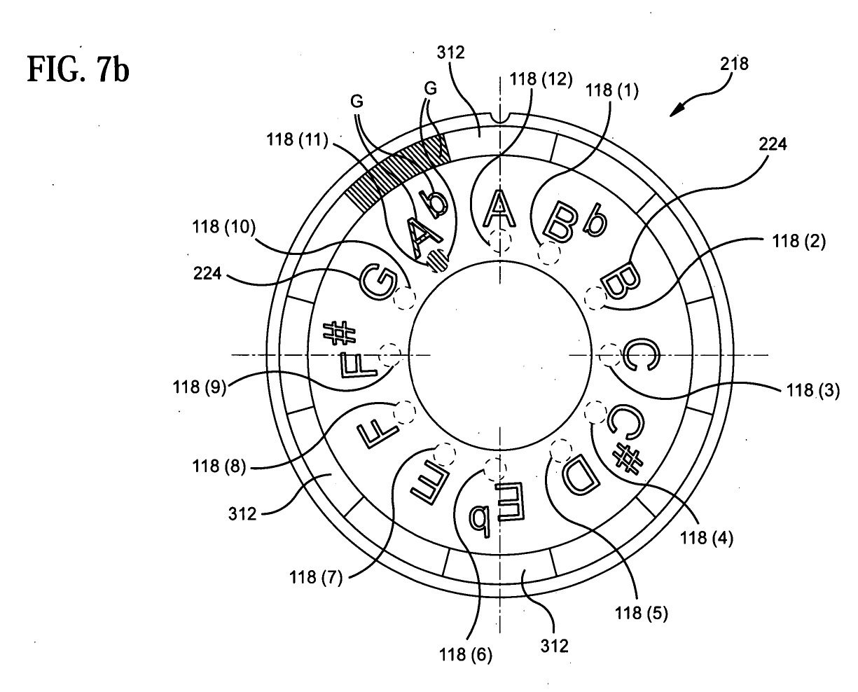

FIG. 7A illustrates the sweep mode of operation when the musical note being tuned is G#/Ab. The indicia for note G#/Ab is positioned at the 11 o'clock position on the note dial 218. LED 118(11) corresponding to this reference note 224(11) is illuminated in green (G). In this case, the angular extent of the illuminated red LEDs 118 are from the 6 o'clock position represented by LED 118(6) to the 10 o'clock position represented by LED 118(10) (flat 50 cents) and from the 4 o'clock position represented by LED 118(4) to the 12 o'clock position represented by LED 118(12) (sharp 50 cents). LED 118(5) in the 5 o'clock position on the note dial 218 is not illuminated in order to provide a clear demarcation between the red LEDs 118 situated counter-clockwise of the green reference note LED 118(11), which signify that the played note is flat, and the red LEDs 118, clockwise of the green reference note LED 118(11), which signify that the played note is sharp. FIG. 7A illustrates LED 118(2), and segment 312a corresponding thereto (as well as the note B indicia 224 lit by LED 118(2)), as being illuminated in red, indicating that the played note is sharp with respect to the reference note G#/Ab.

As before, the microcontroller 112 illuminates in red one of the plurality of LEDs 118(4), (3), (2) (1), (12) or LEDs 118(10), (9), (8), (7), (6) to represent proportionally the difference between the frequency of the played note and the frequency of the reference musical note (G#/Ab), corresponding to LED 118(11), illuminated in green (G).

As illustrated by FIG. 7B, when the user has tuned his instrument 10 or 20 such that the frequency of the played note corresponds to the frequency of the reference note G#/Ab 224(11), only the green LED 118(11) remains illuminated. All of the red LEDs 118 are extinguished by the microcontroller 112.

It should be noted that the microprocessor 112 can pulse width modulate the illumination of adjacent red LEDs 118 to show a smooth movement of the pitch of the played note as the musical instrument is being tuned. Thus, only one green LED 118, signifying the reference note 224, is illuminated at any one time, but two adjacent red LEDs 118, signify how sharp or flat the played note is, may be pulse width modulated to at least partially illuminate together to provide a smoothly varying display.

When the user presses the mode pushbutton switch 120 a second time, the electronic tuner 300 enters the strobe mode of operation. The LEDs 118 illuminate sequentially in red around the note dial 218 a few times to indicate to the user that the tuner 300 is in the strobe mode.

In the strobe mode of operation, the LED 118 corresponding to the note played lights up in one color, for example, green. The other LEDs 118 sequentially illuminate in a different color, for example, red, in either a counter-clockwise or clockwise direction about the note dial 218. Both the direction and speed of the illuminating red LEDs 118 provide information to the user as to how out of tune the instrument is. When the red LEDs 118 illuminate sequentially in a counter-clockwise direction, this indicates that the played note is flat compared to the reference note 224. When the red LEDs 118 sequentially illuminate in a clockwise direction, this indicates to the user that the played note is sharp compared to the reference note 224. The angular velocity or speed at which the red LEDs 118 sequentially illuminate is proportional to how sharp or flat the played note is. As the instrument 10 or 20 is tuned so that the frequency of the played note approaches the frequency of the reference note 224, the angular velocity or speed at which the red LEDs 118 sequentially illuminate decreases and then stops, indicating that the note is in tune.

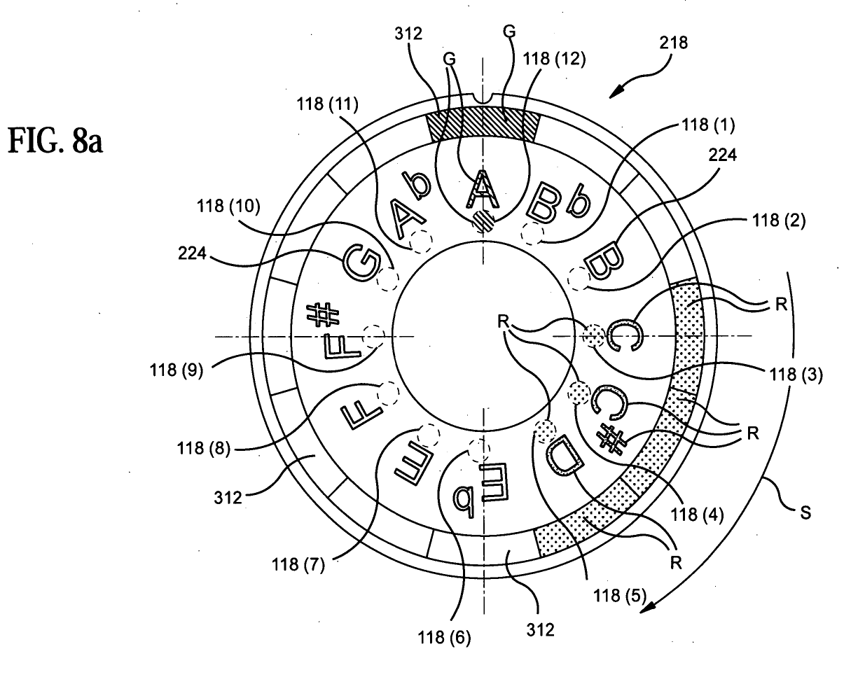

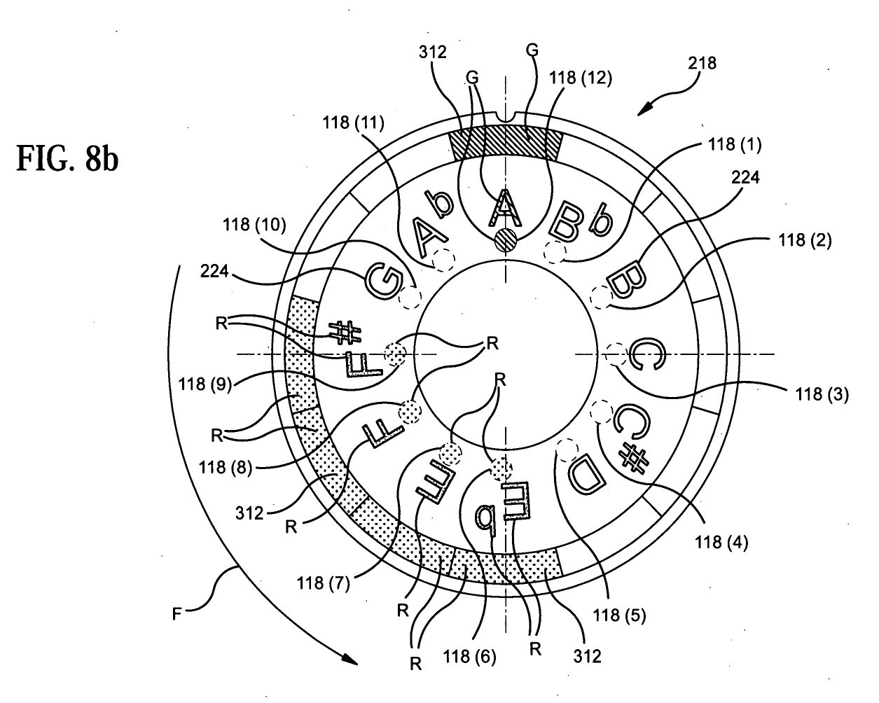

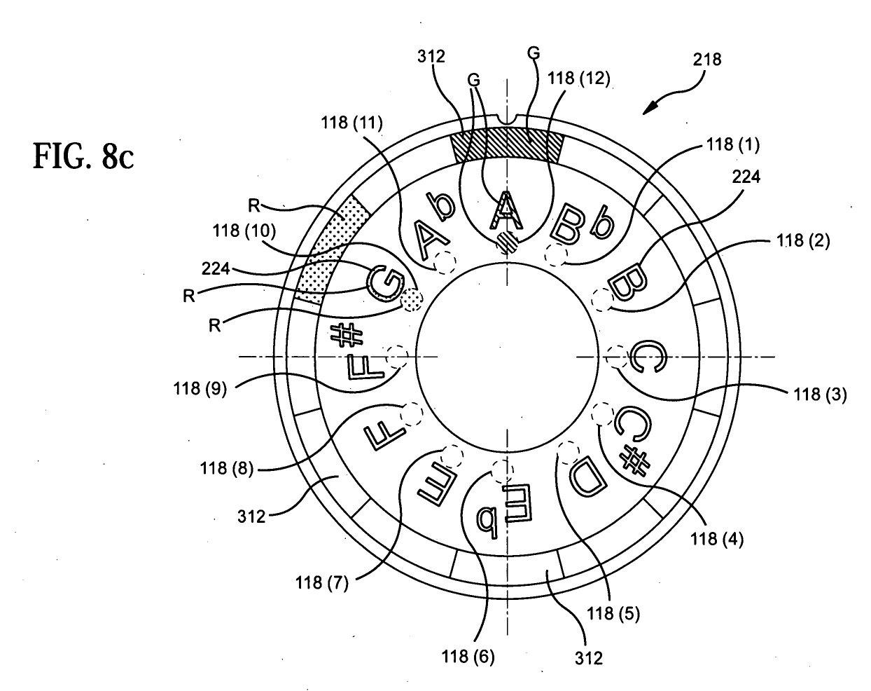

FIG. 8A illustrates the note dial 218 in the strobe mode of operation. Assuming that the user wishes to tune musical note A of the musical instrument 10 or 20, the microprocessor or microcontroller 112 receives the digitized electrical signal 16 corresponding in frequency to the note played on the acoustic musical instrument 10 or the electronic musical instrument 20. By means of frequency comparator 116, the microprocessor 112 compares the frequency of the electrical signal 16 to the fundamental frequencies of the musical notes stored in the storage memory 114 and determines which one of the musical notes is being tuned by determining which musical note has a fundamental frequency most nearly equal to the frequency of the electrical signal 16, for example, note A. Musical note A thus becomes the reference musical note. The microcontroller 112 then illuminates LED 118(12), corresponding to musical note A at the 12 o'clock position on the note dial 218 in a particular color, preferably green. This process is the same as that which occurs in the sweep mode of operation described previously.

In the strobe mode of operation, if the frequency of the played note is less than that of the reference note A such that the played note is flat, the microcontroller 112 illuminates the LEDs 118(1) through (11) sequentially in a counter-clockwise direction about the note dial 218 and in a different color, such as red. If the frequency of the played note is greater than that of the reference note A such that the played note is sharp, the microcontroller 112 illuminates sequentially in red the LEDs 118(1) through (11) in a clockwise direction about the note dial. The microcontroller 112 causes the LEDs 118(1) to (11) to illuminate and extinguish sequentially around the note dial 218 at an angular velocity ω.

However, the greater the deviation between the frequency of the played note and the frequency of the reference note 224, in this example, note A, the greater is the effective angular velocity ω of the sequential illumination of the red LEDs 118. As the user tunes the instrument 10 or 20 such that the frequency of the played note approaches the frequency of the reference note 224, the effective angular velocity ω of the sequential illumination decreases.

For the example illustrated in FIG. 8A, the intonation of the played note is sharp and a sharp intonation is arbitrarily represented by a clockwise LED sequential illumination (illustrated in FIG. 8A as being in the direction of arrow S) having an effective angular velocity ω. FIG. 8A illustrates LEDs 118(3), 118(4) and 118(5), and their corresponding musical note indicia 224 and segments 312, as being sequentially illuminated in red and extinguished in a clockwise direction to indicate that the played note is sharp with respect to the reference note A. If the frequency of the played note 14 is flat as compared to the frequency of the reference note 224, e.g., note A, or if the user tunes the note past the frequency of the reference note A, i.e., from sharp to flat, as illustrated in FIG. 8B, the microcontroller 112 again controls the LEDs 118(1) through (11) to illuminate and extinguish sequentially, but instead of a clockwise direction, the illumination is now in a counter-clockwise direction (illustrated in FIG. 8B as being in the direction of arrow F). FIG. 8B illustrates LEDs 118(9), 118(8), 118(7) and 118(6), and their corresponding musical note indicia 224 and segments 312, as being sequentially illuminated in red and extinguished in a counter-clockwise direction to indicate that the played note is flat with respect to the reference note A.

As illustrated in FIG. 8C, once the user tunes the played note to the correct frequency of the reference note, regardless of whether the played note was initially flat or sharp, the angular velocity ω of the sequential illumination of the red LEDs decreases to zero such that only one red LED 118 remains lit (i.e., no further sequential illumination occurs) or no red LEDs 118 remain lit. The reference note LED (in this case, LED 118(12)) remains illuminated in green (G). FIG. 8C illustrates LED 118(10) and the musical note indicia 224 and segment 312 corresponding thereto, as being steadily illuminated in red, indicating that the played note corresponds in frequency to that of the reference note A and that the musical instrument is in tune with respect to that note.

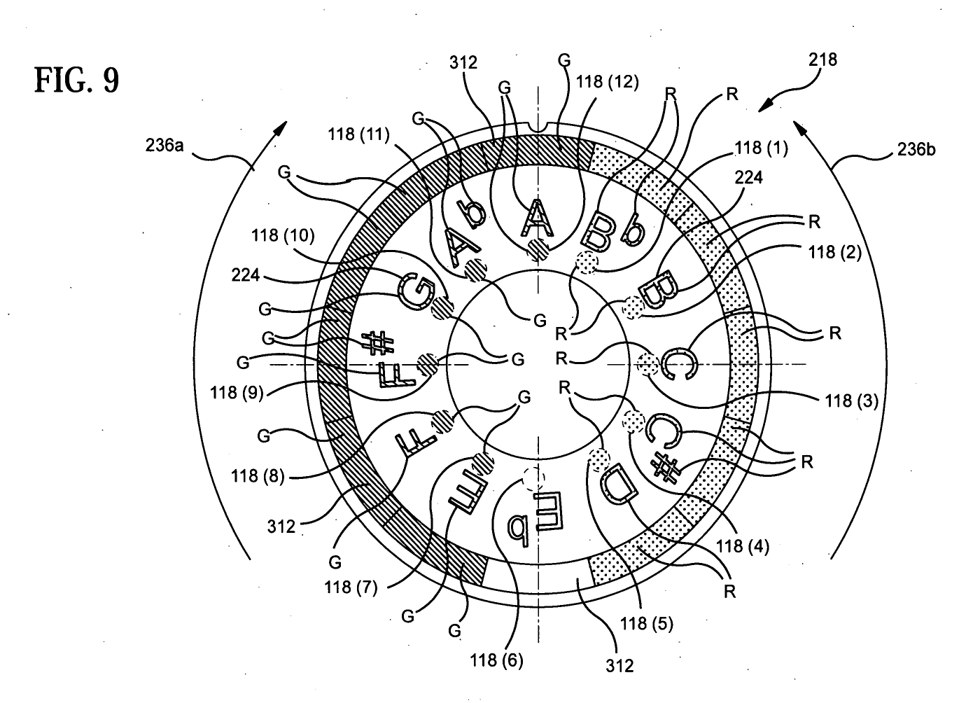

FIG. 9 is a front view of the display interface with the note dial 218 illustrating the power off mode of operation. The user turns off the power to the electronic tuner 300 after the strobe mode of operation by pressing the display mode selector switch 120.

To indicate to the user that the tuner is powering down, and as further illustrated in FIG. 9, the microcontroller 112 illuminates and extinguishes the LEDs 118(7) through (12) sequentially in a clockwise direction, typically in one color such as green, as represented by clockwise arrow 236a. Simultaneously, the microcontroller 112 illuminates and extinguishes the LEDs 118(5) through (1) sequentially in a counter-clockwise direction, preferably in another color such as red, as represented by counter-clockwise arrow 236b. Once the LEDs 118(1) through (5) and (7) through (12) are extinguished, and the entire display is unlit, the tuner circuit 100 has powered down. The mode switch 120 must be pressed again to re-energize the tuner.

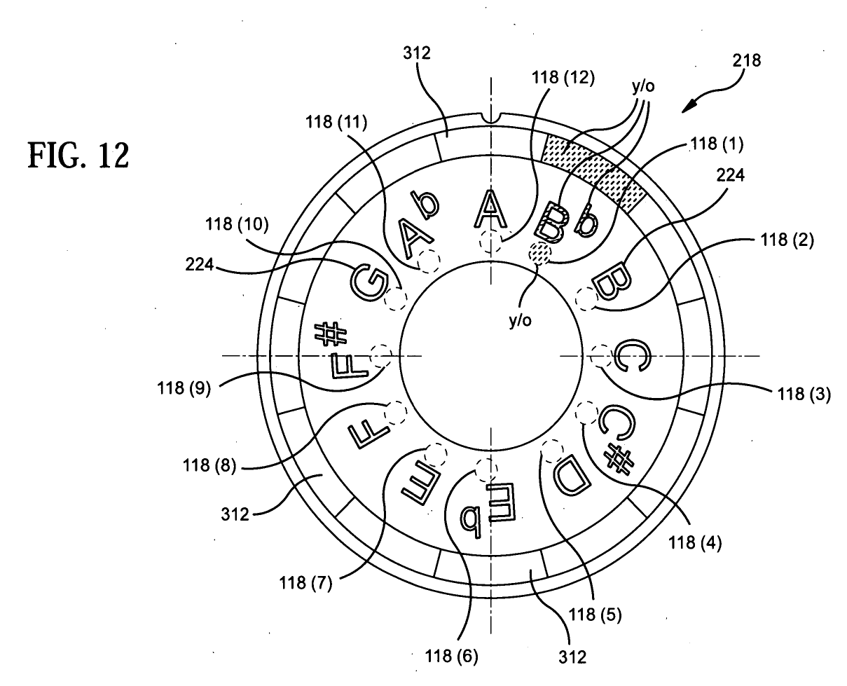

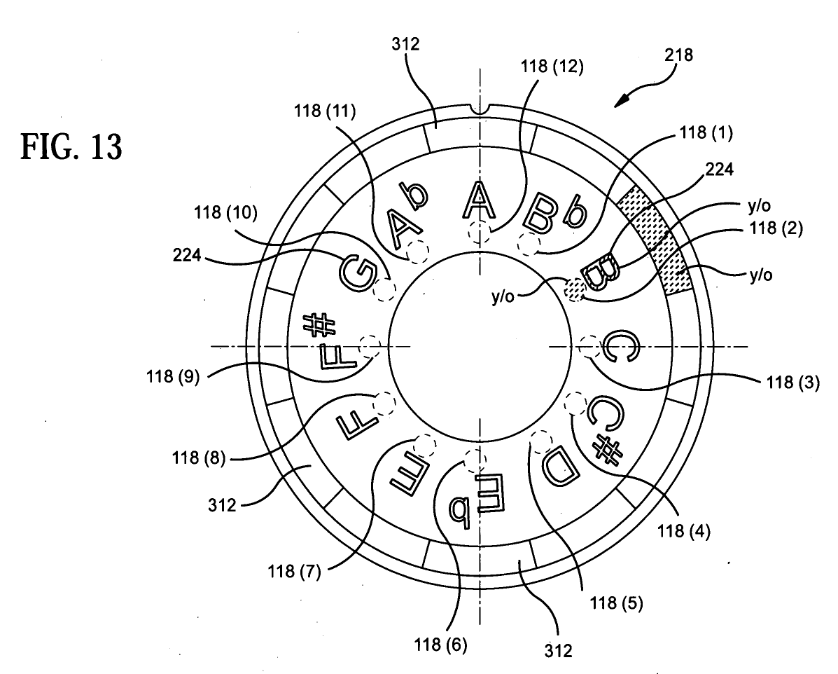

Returning again to the exploded views of the in-line electronic tuner shown in FIGS. 3 and 4, the circuit 100 includes a reference pitch selector switch 122. The electronic tuner operates on a standard pitch of 440 Hz for the note A. However, it is often desired to tune a musical instrument to a slightly different reference frequency from that of the standard pitch of 440 Hz. Accordingly, the electronic tuner provides the user with the ability to select a different reference frequency, preferably between 435 Hz and 445 Hz for note A. This capability is explained below with reference to FIGS. 12 through 13C.

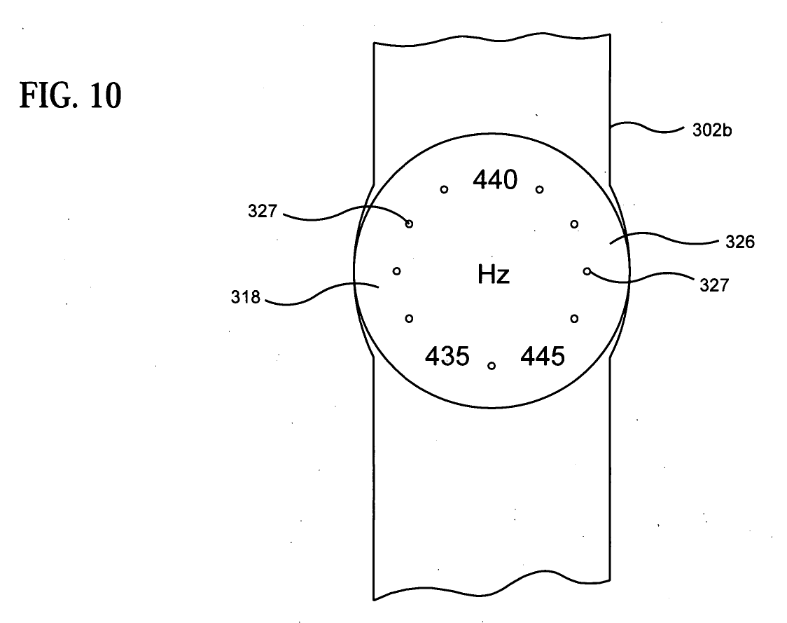

FIG. 10 illustrates a reference frequency indication chart 318 which is preferably imprinted on the removable cap 326 of the rear half of the tuner housing 302b and opposite and behind the note dial 218. The reference frequency indication chart 318 displays the reference frequency 435 Hz at the 7 o'clock position and the reference frequency 445 Hz at the 5 o'clock position. The intermediate frequencies are implied by imprinted dots 327, with frequency 436 Hz being at the 8 o'clock position, 437 Hz being at the 9 o'clock position, etc. The 6 o'clock position does not correspond to any calibration frequency.

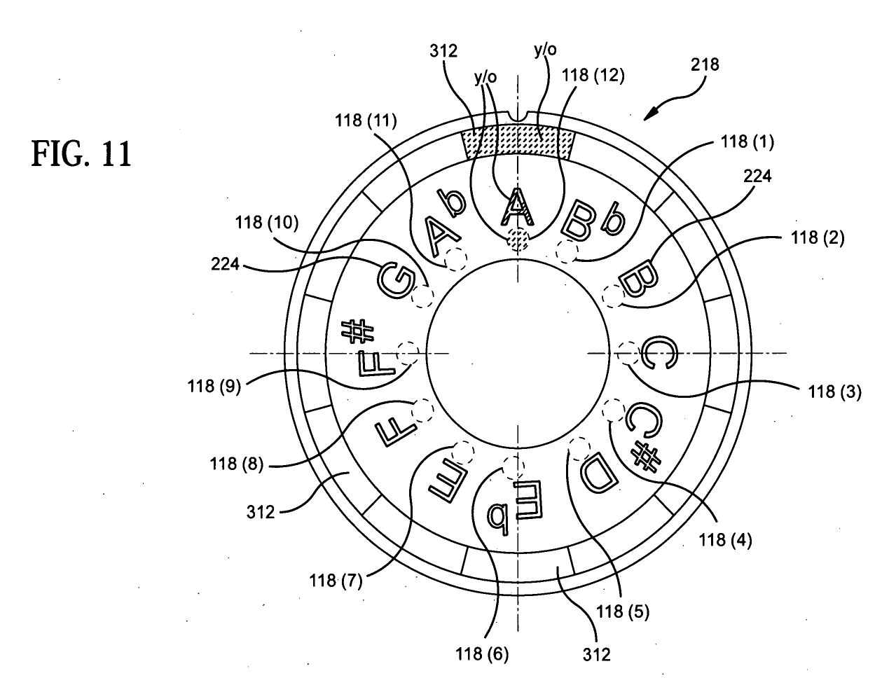

FIG. 11 illustrates the note dial 218 with a display occurring when the reference pitch selector switch 122 is first pressed. That is, the microcontroller 112 signals the LED 118(12), corresponding to reference frequency 440 Hz on the chart 318, to illuminate in a particular color, such as yellow/orange (Y/O), which is achieved by energizing the green and red segments of the bi-color LEDs 118 simultaneously. The corresponding musical note indicia 224 and segment 312 thus also illuminate in the same color. This particular color indicates to the user that the tuner circuit 100 is in a frequency calibration mode. As shown in FIG. 12, when the user again presses the reference pitch selector switch 122, the microcontroller 112 then illuminates LED 118(1), aligned with and corresponding to a reference frequency of 441 Hz on chart 318, and LED 118(12) is extinguished. The indicia 224 and segment 312 associated with LED 118(1) also illuminate in the same color. In FIG. 13, when the user again presses the reference pitch selector switch 122, the microcontroller 112 illuminates LED 118(2), aligned with and corresponding to a reference frequency of 442 Hz on chart 318, and LED 118(1) is extinguished. Similarly, the indicia 224 and segment 312 associated with LED(2) also illuminate in yellow/orange. A user-selected reference frequency is thereby programmed into microcontroller 112, and is conveniently indicated to the user by the illumination of the corresponding LED 118 in yellow/orange. Therefore, by continually pressing the reference pitch selector switch 122, the user can establish any frequency from 435 Hz to 445 Hz as the calibration reference frequency.

The microcontroller 112 is preferably a general purpose 8 bit microcontroller having Part No. S3C9428, manufactured by Samsung Electronics Co. Ltd. of Seoul, Korea, and which selectively illuminates the LEDs 118 of the display interface.

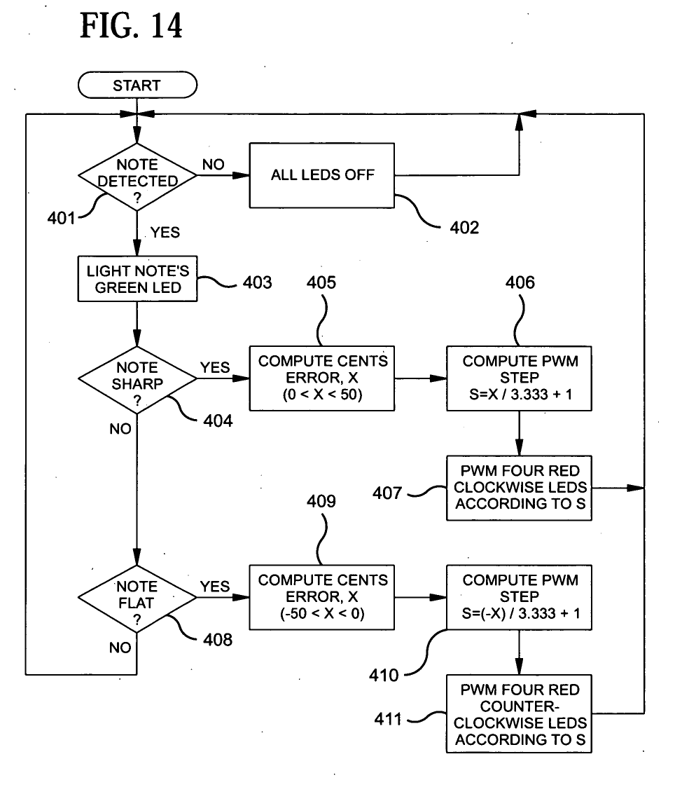

The operational flowchart for the microcontroller 112 for operation of the tuner in the sweep mode is shown in FIG. 14. The microcontroller 112 first determines whether a signal has been detected (Block 401). If not, then the microcontroller turns off the display to conserve power (Block 402).

If a signal has been detected, the microcontroller lights the closest green LED corresponding with the detected note, within +/−50 cents (Block 403). For example, if a note C were detected, sharp by 30 cents, the C green LED would be lit.

The microcontroller 112 further determines if the note is sharp (Block 404). If so, then the microcontroller in a number of operational steps shown by Blocks 405, 406 and 407 in FIG. 14 acts to light the one or two of the four red LEDs clockwise of the green LED lit by the microcontroller in the step exemplified by Block 403, as will be described in detail presently. The high level goal is to provide a smoothly varying indication to the user of how sharp the note is by the angular displacement of the red LED indication from the green LED.

A simplistic solution would be to light one of the four red LEDs clockwise of the green LED as a function of the error, dividing the 50 cent error band into four sub-bands of 12.5 cents apiece. Such operation is functional but not subjectively pleasing to the user, as the steps are too coarse.

As shown by Block 405, the microcontroller 112 computes the error, X, in cents, a positive value from 1 to 50 cents for a sharp deviation. The microcontroller 112 then computes a fine step, S, from the error, X, resulting in a value of S ranging from 1 to 16 (Block 406).

Then, and as shown in Block 407, the microcontroller takes the step, S, and pulse width modulages (PWM) the four red LEDs clockwise of the green LED. As the step varies from 1 to 16, LEDs successively further away from the green LED are lit. The following table details the preferred PWM duty cycle (as a percentage, 100%=LED fully lit, 0%=LED off) for each LED as a function of the step, S. Note that “LED 1” is physically next to the green LED and “LED 4” is the furthest from the green LED.

| Step, S | LED 1 | LED 2 | LED 3 | LED 4 |
|---|---|---|---|---|
| 1 | 25 | 0 | 0 | 0 |
| 2 | 50 | 0 | 0 | 0 |
| 3 | 75 | 0 | 0 | 0 |
| 4 | 100 | 0 | 0 | 0 |
| 5 | 75 | 25 | 0 | 0 |
| 6 | 50 | 50 | 0 | 0 |
| 7 | 25 | 75 | 0 | 0 |
| 8 | 0 | 100 | 0 | 0 |
| 9 | 0 | 75 | 25 | 0 |
| 10 | 0 | 50 | 50 | 0 |
| 11 | 0 | 25 | 75 | 0 |
| 12 | 0 | 0 | 100 | 0 |
| 13 | 0 | 0 | 75 | 25 |
| 14 | 0 | 0 | 50 | 50 |
| 15 | 0 | 0 | 25 | 75 |
| 16 | 0 | 0 | 0 | 100 |

This PWM mechanism results in a smooth variation in intensity of the red LEDs.

If the note is not sharp as determined by the microcontroller 112 in the step shown in Block 404, then the microcontroller examines the note for a flat condition (Block 408). If this is the case, then the microcontroller 112, in steps exemplified by Blocks 409, 410 and 411 in FIG. 14, performs a similar computation and PWM, as described above for the steps shown in Blocks 405, 406 and 407, respectively.

The cents error is a negative value, as computed by the microcontroller in the step shown by Block 409, since the note is flat. The microcontroller computes a step value, S, ranging from 1 to 16 (Block 410). The microcontroller 112 then uses the table shown previously to PWM LEDs, only this time on the counterclockwise side of the lit green LED, showing a smoothly varying indication of the flatness of the note, as shown by Block 411.

If the microcontroller 112, in Block 408, determines that the note is not flat, then the program flow moves back to the earlier step of Block 401, leaving the green LED lit, indicating that the note is in tune.

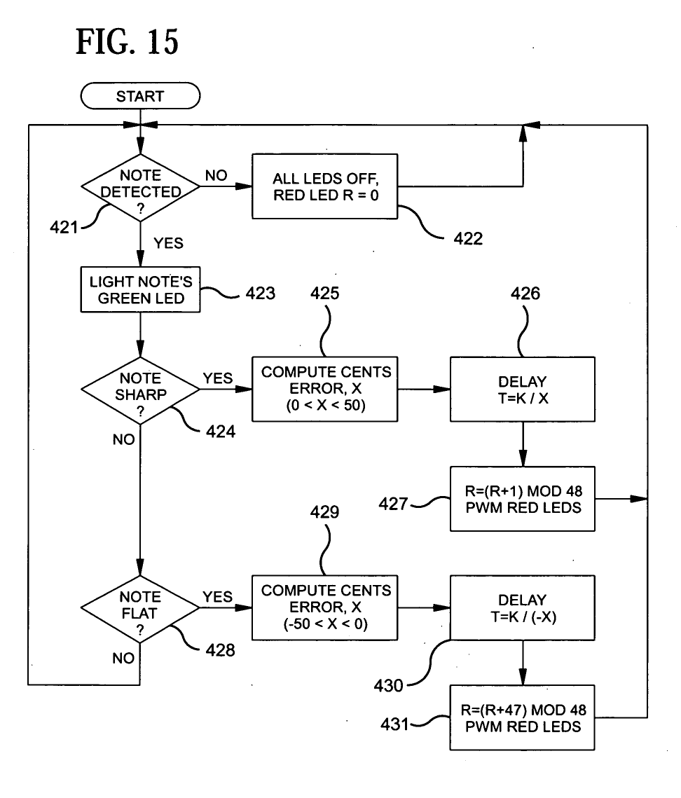

The operational flowchart for the microcontroller 112 for operation of the tuner in the strobe mode is shown in FIG. 15. The microcontroller 112 first determines whether a signal has been detected (Block 421). If not, then the microcontroller turns off the display to conserve power (Block 422). The variable R in Block 422 is an LED index and determines which red LED is currently lit, and is reset to zero in the step shown in Block 422.

The LED index R has values from 0 to 47. The twelve red LEDs are pulse width modulated in four levels each, for a resulting total of 48 intensity states, one for each value of R.

If a signal has been detected, the microcontroller lights the closest green LED corresponding with the detected note, within +/−50 cents (Block 423). For example, if a note C were detected, sharp by 30 cents, the C green LED would be lit.

The microcontroller 112 further determines if the note is sharp (Block 424). If so, then the microcontroller in a number of operational steps shown by Blocks 425, 426 and 427 in FIG. 15 acts to cycle the red LEDs on the tuner face clockwise at a rate proportional to the degree of error. The high level goal is to provide a smoothly varying indication to the user of how sharp the note is by the angular rate of rotation of the red LED indication.

As shown by Block 425, the microcontroller 112 computes the error, X, in cents, a positive value from 1 to 50 cents for a sharp deviation. The microcontroller 112 then performs a time delay of value T, computed as inversely proportional to the error, X (Block 426). This delay serves to set the rotational period of the red LED indication. The constant K in Block 426 would typically take on a value of 0.04. With this value of K and 48 total steps around the circle of the red LED indication, one cent error (X=1) results in a rotational period of about two seconds. Higher error values, X, result in proportionately faster rotational periods by reducing the delay, T.

As shown in Block 427, the microcontroller 112 adds one to LED index R, modulo 48, then and pulse width modulates the red LEDs as indexed by R. For adjacent red LEDs, an overlapping PWM format is used as with the sweep mode in the table above. Thus, as R varies from 0 to 47, a red indication moves clockwise, smoothly and circularly around the display, in much smoother a fashion than would be had if the twelve LEDs were lit in successive twelve steps.

If the note is not sharp as determined by the microcontroller 112 in the step shown in Block 424, then the microcontroller examines the note for a flat condition (Block 428). If this is the case, then the microcontroller 112, in steps exemplified by Blocks 429, 430 and 431 in FIG. 15, performs a similar computation as described above for the steps shown in Blocks 425, 426 and 427, respectively.

The cents error is a negative value, as computed by the microcontroller in the step shown by Block 429, since the note is flat. The microcontroller, in the step shown in Block 430, performs a delay with identical constant of proportionality K as in Block 426.

The microcontroller 112 subtracts one from LED index R, modulo 48, then and pulse width modulates the red LEDs as indexed by R (Block 431). For adjacent red LEDs, an overlapping PWM format is used as with the sweep mode in the table shown previously. Thus, as R varies from 0 to 47, a red indication moves counterclockwise, smoothly and circularly around the display.

If the microcontroller, in Block 428, determines that the note is not flat, then the program flow moves back to the earlier step of Block 421, leaving the green LED lit, and leaving the last red LED indication unchanged and unmoving, indicating that the note is in tune.

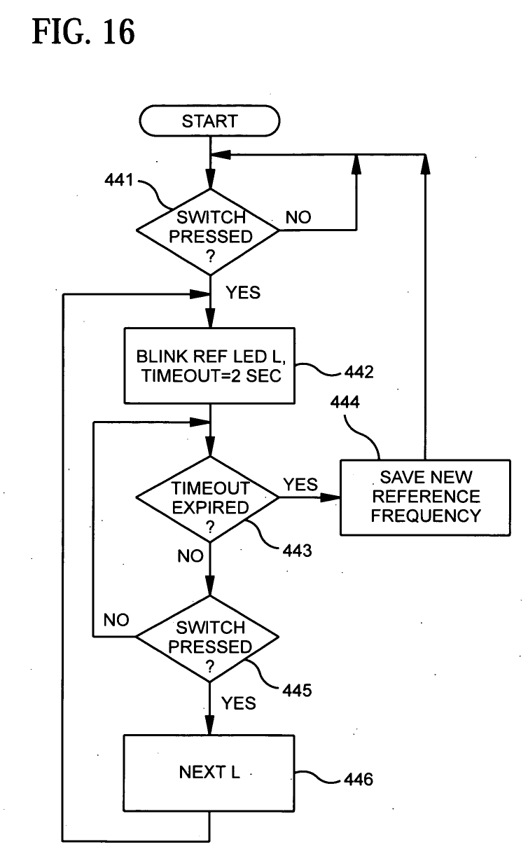

The operational flowchart for the microcontroller 112 for operation of the tuner in the reference frequency selection mode is shown in FIG. 16. The microcontroller 112 first determines whether the reference frequency adjustment switch has been pressed (Block 441). If so, then the microcontroller blinks an LED (indexed by variable L) corresponding to the currently selected reference frequency (Block 442). The LED is blinked using preferably the color yellow by illuminating both red and green LEDs at once. The lit LED corresponds physically to the reference frequency indication chart 318 on the rear of the housing.

The microcontroller 112 also starts a timer of duration 2 seconds (Block 422).

The microcontroller, in the step shown in Block 443, tests whether the timeout has expired. If so, the microcontroller saves the newly selected (or possibly the previous value of the) reference frequency for future use in tuning operations (Block 444). If the timeout has not expired, the microcontroller detects if further presses of the switch occur (Block 445).

If the switch is pressed, the microcontroller in the step shown in Block 446 of FIG. 16 selects the next L value and branches to the step shown in Block 442 to update the display. The L values, LEDs and reference frequencies are selected preferably in this order, one step with each press of the switch (refer to FIG. 10): 440 Hz, 441 Hz, 442 Hz, 443 Hz, 444 Hz, 445 Hz, 435 Hz, 436 Hz, 437 Hz, 438 Hz, 439 Hz, then back to 440 Hz. This sequence is enforced by the logic in the step shown in Block 446.

There are several variations and modifications of the display interface described previously that are envisioned to be within the scope of the present invention. For example, one variation is where the light pipe 308 is omitted, and the light emitting devices 118 themselves situated in a spaced apart, circular manner may function in the same manner as segments 312 by selectively lighting to advise the user whether his instrument is in tune. The light given off by each light emitting device 118 may be sufficient to also directly illuminate the corresponding note indicia on note dial 218, or a second array of separate light emitting devices situated in alignment with respective note indicia on note dial 218 may be used to directly illuminate the note indicia.

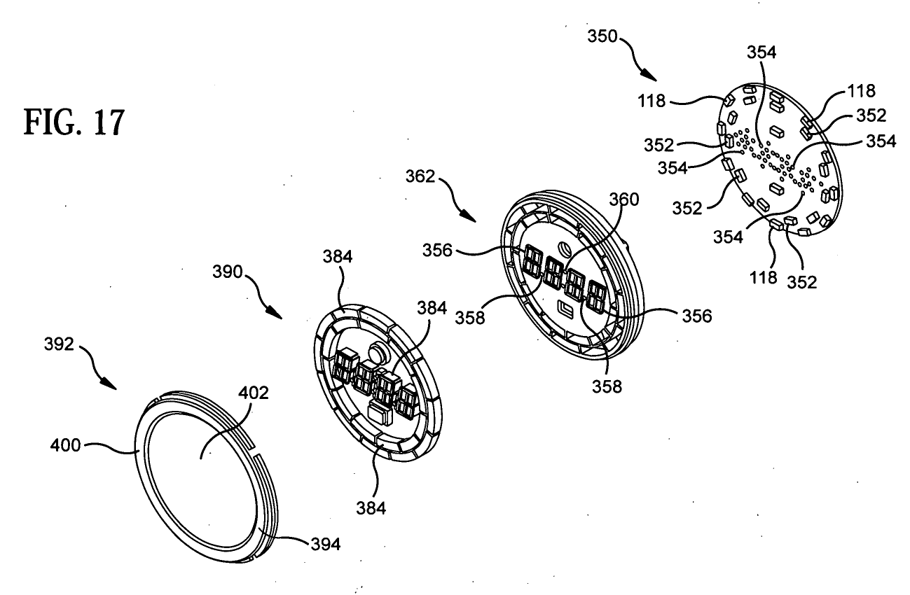

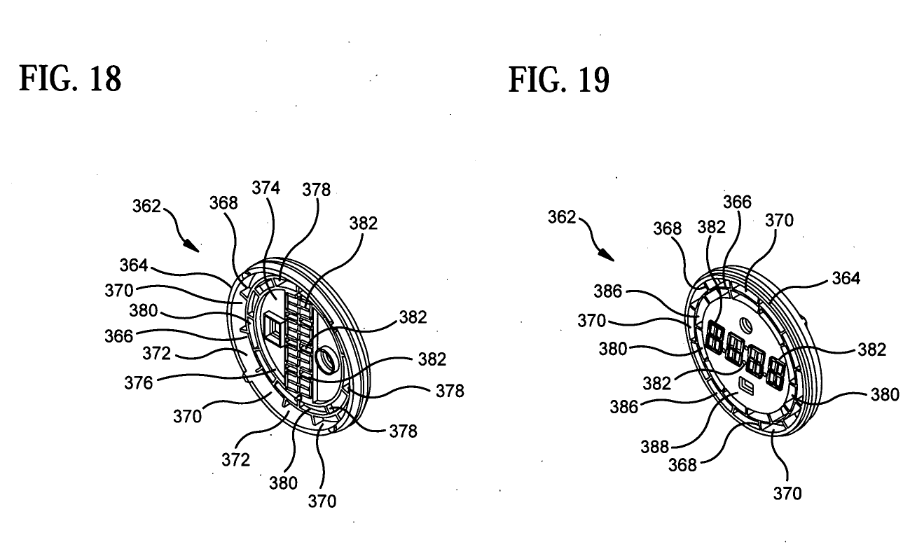

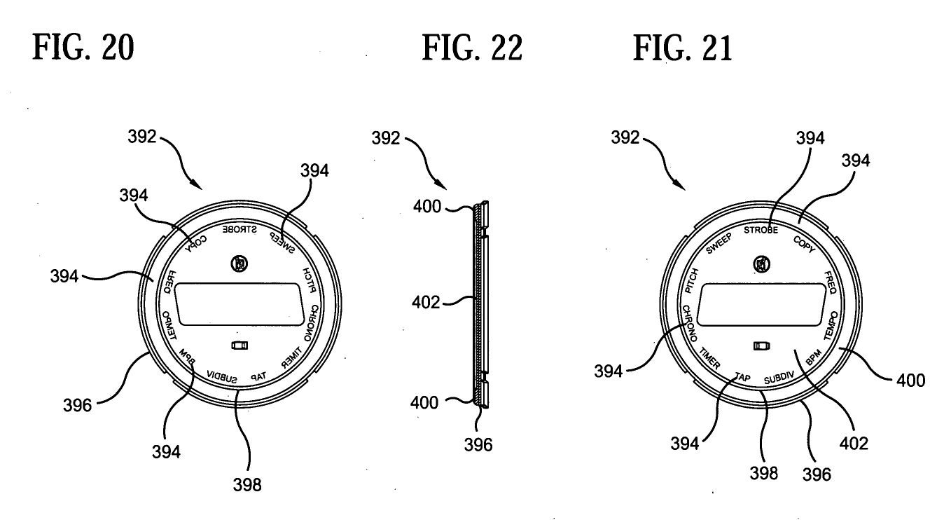

A further alternative embodiment of the display interface is shown in FIGS. 17-22. Here, the display interface of the present invention does not include the light pipe shown in FIGS. 4A and 4B, but rather, a resin diffuser 390.

More specifically, the display interface in this alternative configuration includes an outer circular array of spaced apart, light emitting devices 118, such as light emitting diodes (LEDs) mounted on a round printed circuit board 350. In this embodiment, the printed circuit board 350 may include an inner circular array of LEDs 352, concentric to the outer LED array 118, to illuminate silk-screened indicia on the lens 392 of the tuner to advise the user as to what mode the tuner is operating in, e.g., “SWEEP”, “STROBE”, “COPY”, “FREQ” (frequency), “TEMPO”, “BPM” (beats per minute), and others. The printed circuit board 350 also has preferably mounted on it, among other circuitry of the electronic tuner, a plurality of sub-miniature light emitting devices 354, such as LEDs, particularly arranged on the printed circuit board as a four digit, 10 segment per digit display 356, with additional LEDs to provide decimal points 358 and a colon 360 for the display 356, for displaying the musical note played (e.g., C, C#, D, D#, etc.), as well as different operational modes, for example, as a metronome. The LEDs 118, 352 of the outer and inner circular array may be part no. SML-LXL1206XC-TR, manufactured by Lumex, Inc. of Palatine, Ill., or an equivalent thereof. The sub-miniature LEDs 354 for illuminating the four digit display 356 may be part no. SML-LXF0603XC-TR, also manufactured by Lumex, Inc., or an equivalent thereof.

A display cover 362 is situated adjacent to the printed circuit board 350. The display cover 362 acts essentially as a form for receiving a light diffusing resin 384, as will be explained in greater detail. The display cover 362 is preferably circular in overall shape, and includes an outer circumferential wall 364 and at least a first inner circular wall 366 concentrically situated within and disposed radially inwardly of the outer circumferential wall 364. A plurality of spaced apart first dividing walls 368 extending radially between the outer circumferential wall 364 and the first inner circular wall 366 divide the space between the outer wall 364 and the first inner wall 366 into a plurality of circumferentially arranged, arcuate first segments 370, preferably 12 in all. Each segment is open with a first open end 372 on the inner axial face 374 of the display cover, which faces the printed circuit board 350, and is aligned with a respective LED 118 on the printed circuit board, so that a respective LED 118 is received by one corresponding segment 370 of the display cover 362, which permits the display cover to be situated closely to the surface of the printed circuit board 350 on which the LEDs 118, 352, 354 are mounted. These first segments 370 function similarly to segments 312 of the first embodiment of the display interface shown in FIGS. 4A and 4B.

The display cover 362 may further include a second inner circular wall 376 concentrically situated within and disposed radially inwardly of the first inner circular wall 366. A plurality of spaced apart second dividing walls 378 extending radially between the first and second inner walls 366, 376 divide the space between the first and second inner walls into a plurality of arcuate second segments 380, preferably 11 in all. Like the first segments 370, each of the second segments 380 is open on the inner axial face 374 of the display cover, and is aligned with a respective LED 352 of the inner row of LEDs that display the tuner mode so that a respective LED 352 is received by one corresponding second segment 380 of the display cover.

The display cover 362 also has a plurality of openings 382 formed through its thickness. The openings 382 are situated in a similar arrangement to that of the sub-miniature LEDs 354 to define the segments of the four digit, ten segment per digit display 356, and the decimal points 358 and colon 360 of the display. The openings 382 are arranged to be aligned with respective ones of the sub-miniature LEDs 354 on the printed circuit board 350 so that a respective sub-miniature LED 354 is received by one corresponding opening 382 of the display cover.

After the printed circuit board 350 is fitted onto the display cover 362, preferably closely within the confines of the outer circumferential wall 364 of the cover, a light transmissive, optical resin 384 is poured into the first segments 370, second segments 380 and openings 382 formed through the display cover, each of which is also open with second open end 386 on the opposite outer axial face 388 of the display cover, through which open ends 386 the resin is poured, and the resin-filled display cover is baked to allow the resin to cure. A suitable optical resin 384 for use with the display interface of the present invention is a Hysol Epoxy mixture (95% OS1600 and 5% AC7088), manufactured by Henkel Technologies of Dusseldorf, Germany, or an equivalent thereof. The solidified resin 384 forms a light diffuser 390 and is shown by way of example in FIG. 17, although the optical resin 384 filling the segments, openings and interstices of the display cover 362 is in reality not separable from the display cover once it cures. The optical resin light diffuser 390 acts to diffuse light emitted by the LEDs throughout the first and second segments 370, 380 and openings 382 formed in the display cover 362, with the display cover 362 blocking light emitted by the LEDs beyond the outline of the segments and openings, to provide a highly discernible optical display for the user of the electronic tuner.

A lens 392, preferably formed of an optically clear polycarbonate, which transmits light therethrough, is situated adjacent to the outer axial face 388 of the display cover 362. The lens 392 includes silk-screened artwork 394 positioned over and in alignment with the second segments 380 of the display cover 362 and corresponding LEDs 352 of the inner circular array of LEDs. The artwork 394, when illuminated, display for the user the particular operational mode in which the electronic tuner is currently functioning, as described previously (e.g., “SWEEP”, “STROBE”, “COPY”, etc.). Light emitted by the outer circular array of LEDs 118, which are particularly used in the sweep and strobe modes and which selectively illuminate to light the outer, first segments 370 of the display cover, through the light diffuser 390, is viewable through the lens 392 within a circular clear band 394 defined by and between the outer circumferential edge 396 of the lens and/or a silk-screened ring positioned at the edge 396 and a radially inwardly and concentrically disposed silk-screened ring 398. The clear band 394 may further be defined as a protruding portion 400 of the front face 402 of the lens.

It should be noted that the outer circular array of LEDs 118, the inner circular array of LEDs 352, and the sub-miniature LEDs 354 may function independently of one another to selectively illuminate the first segments 370, or the second segments 380 or the four digit display 356, without necessarily illuminating any other of the segments or four digit display.

The embodiment of the display interface shown in FIGS. 17-22 may operate and function in the same or similar manner as the display interface described previously and shown in FIGS. 3 and 4. Alternatively, and preferably when used in a foot operated electronic tuner, as mentioned previously, the display interface may function in the following manner, particularly with respect to the strobe and sweep modes.

More specifically, in the strobe mode of operation, the closest reference note to the played note recognized by the circuit of the electronic tuner is displayed on the four digit display 356 or another alphanumeric display (not shown). The outer first segments 370 are rotationally sequentially illuminated and extinguished in one color, for example, red, so that the illuminated segments appear to race around the circumference of the lens 392 in either a clockwise direction, if the played musical note is determined by the circuit of the electronic tuner to be sharp with respect to the recognized reference note, and in a counter-clockwise direction, if the played note is determined to be flat. Also, the angular velocity ω of the sequential illumination of the segments 370 is proportional to the deviation in frequency between the played note and the reference note so that, as the musician tunes the instrument closer to the reference note, the speed at which the lighted segments 370 appear to race around the face of the lens 392 slows. When the musical instrument is in tune, such that the frequency of the played note is substantially equal to that of the reference note, the lighted red segments 370 appear to stop moving, and preferably are extinguished, and the segment 370 at the 12 o'clock position (such as the segment 312 illuminated by LED 118(12) in FIG. 8A) lights preferably in a different color, such as green, to advise the musician that the instrument is in tune for that note played. Preferably, for tuning the instrument for any note, the same segment 370, such as the segment at the 12 o'clock position, is illuminated when the instrument is in tune for that particular note. Of course, it is envisioned that the musician may be advised by the circuit of the electronic tuner that the instrument is in tune in many other ways, such as by illuminating the 12 o'clock segment in the same color (red, for example), by illuminating a segment 370 other than that disposed at the 12 o'clock position, by illuminating more than just one segment 370, by flashing one or more segments 370, or by providing an indication on the four digit display 356 or other alphanumeric display.

In the sweep mode of operation, again the closest reference note to the played note recognized by the circuit of the electronic tuner is displayed on the four digit display 356 or another alphanumeric display. A particular outer first segment 370 is illuminated in one color, for example, red, to show the relative difference in frequency between the played note and the reference note. The angular position of the illuminated segment 370 from a chosen segment, for example, the segment at the 12 o'clock position, which acts as a reference point on the display interface, indicates to the musician the relative deviation in frequency of the played note from that of the reference note. A segment 370 positioned clockwise of the 12 o'clock segment, for example, those that are illuminated by LEDs 118(1), 118(2), 118(3), 118(4) and 118(5), as shown in FIG. 6B, when illuminated, indicates that the played note is sharp with respect to the reference note, with the segment illuminated by LED 118(5) indicating that the played note is sharper than if the segment corresponding to LED 118(4), or LED 118(3), 118(2) or 118(1), were illuminated, for example. A segment 370 positioned counter-clockwise of the 12 o'clock segment, for example, those that are illuminated by LEDs 118(7), 118(8), 118(9), 118(10) and 118(11), as shown in FIG. 6B, when illuminated, indicates that the played note is flat with respect to the reference note, with the segment illuminated by LED 118(7) indicating that the played note is flatter than if the segment corresponding to LED 118(8), or LED 118(9), 118(10) or 118(11), were illuminated, for example.

As the instrument is being tuned to the reference note in the sweep mode, the segments 370 closer to the 12 o'clock segment will be sequentially illuminated, while the segments farther away will be sequentially unlighted, to show the musician that the frequency of the played note is approaching the frequency of the reference note. If the musician mistakenly detunes the instrument, the opposite response is displayed on the display interface the segments 370 farther away from the 12 o'clock segment will illuminate and those segments closer to the 12 o'clock segment will be unlighted, showing that the played note is being tuned sharper or flatter from the reference note.

When the musical instrument is in tune with respect to a particular played note, where the frequency of the played note substantially equals that of the reference note, all of the segments except for the segment at the 12 o'clock position are unlighted, and the segment at the 12 o'clock position is illuminated, preferably in a different color, for example, green.

With the foot operated electronic tuner in the sweep mode, the relative deviation in frequency between a played note and a reference note is preferably always displayed by the angular distance from an illuminated segment relative to the segment at the 12 o'clock position, no matter what the played or reference note is, that is, all displays of the played note being flat or sharp are made relative to the 12 o'clock segment, or some other chosen segment about the face of lens 392 which acts as a reference point to display the relative difference in frequency between the played note and the reference note.

Also, in the same or similar manner to the operation of the aforementioned electronic tuner in the strobe mode, when the musical instrument is in tune with respect to a particular note, and when the tuner is operating in the sweep mode, the musician may be advised of this by illuminating the 12 o'clock segment in a different color, such as green, or in the same color, such as red, by illuminating a segment 370 other than that disposed at the 12 o'clock position, by illuminating more than just one segment 370, by flashing one or more segments 370, or by providing an indication on the four digit display 356 or other alphanumeric display.

As may be realized from the foregoing description, a display interface for an electronic tuner provides a compact, inexpensive and easily discernible display having bi-color LEDs 118 which are arranged in a preferably circular array as an illuminated dial display. This arrangement enables a user to readily determine whether a musical instrument is in tune and to quickly determine the effects of manual tuning adjustment. The display interface provides the user with two major modes of operation, which are a sweep mode and a strobe mode, for the user to determine when his musical instrument has been properly tuned. The calibration reference frequency used in the electronic tuner can be easily selected by the user. The circular array of LEDs illuminatable in different colors on the display interface provides a user friendly, continuous display of sequentially illuminatable musical notes and arcuate segments in a compact form that are easily viewable by the user.

It can be further seen from the foregoing description that the light emitting devices can be preferably situated in any number of various continuous, closed loop arrangements, and need not be arranged circularly. The light emitting devices may be arranged in an oblong loop or polygonal loop so that the light emitting devices may appear to race around the loop when sequentially illuminated in the strobe mode of tuner operation. The light pipe 308 and the note dial 218, if such are included, of the first embodiment shown in FIGS. 3 and 4, may be similarly shaped, if necessary, to conform to the shape of the continuous, closed loop arrangement of light emitting devices. Similarly, the display cover 362, light diffuser 390 and lens 392, if such are included, of the second embodiment of the display interface shown in FIGS. 17-22, may be similarly shaped, if necessary, to conform to the shape of the continuous, closed loop arrangement of the light emitting devices.

It should be further realized that a light pipe is not a necessary element of the display interface of the present invention. It may be desirable to use the structure of the embodiment of the display interface shown in FIGS. 17-22, or alternatively to use optionally a component which provides a plurality of segmented elements that function like segments 312 or 370, and which are selectively illuminatable by the light emitting devices of the continuous, closed loop arrangement. Furthermore, a liquid crystal display, video or other type of display, either monochrome or multi-colored, may be used to define the segments 312 or 370, in a continuous, closed loop arrangement, where the segments are selectively illuminated to provide and perform one or both of the sweep and strobe functions of the display interface, as described hereinbefore.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. A display interface for an electronic tuner for tuning a musical instrument, which comprises:
a plurality of spaced apart, separately illuminatable light emitting devices situated in a continuous circular array;
a cylindrically-shaped light pipe, the light pipe having radially extending slits formed therein to define individually illuminatable segments, the light pipe being situated in proximity to the circular array of light emitting devices, wherein each segment of the light pipe is illuminatable by a respective light emitting device; and
a disc-shaped note dial, the note dial being situated in proximity to the light pipe, the note dial having illuminatable indicia on a surface thereof corresponding to musical notes, the indicia being illuminatable by the light pipe for viewing by a user of the electronic tuner.

2. A display interface for an electronic tuner for tuning a musical instrument, which comprises:
a plurality of separately illuminatable light emitting devices;
a cylindrically-shaped light pipe, the light pipe having a plurality of individually illuminatable segments arranged in a continuous circular array, each segment being optically coupled to a respective light emitting device and being illuminatable thereby; and
individually illuminatable indicia corresponding to musical notes disposed in a circular arrangement, the indicia being optically coupled to respective segments of the light pipe and being illuminatable thereby for viewing by a user of the electronic tuner.

3. A display interface for an electronic tuner as defined by claim 1, wherein the light pipe has a surface in which is formed a plurality of recesses, each recess being situated within a respective segment, the recesses at least partially receiving the light emitting devices for facilitating the illumination of the segments.

4. A display interface for an electronic tuner as defined by claim 1, wherein each light emitting device is a bi-color light emitting diode.

5. A display interface for an electronic tuner as defined by claim 1, wherein each segment of the light pipe is illuminatable in at least two different colors.

6. A display interface for an electronic tuner as defined by claim 1, wherein each indicia of the note dial is illuminatable in at least two different colors.

7. A method of displaying to a user of an electronic tuner for a musical instrument whether a played note is in tune and the intonation of the played note with respect to a reference musical note, which comprises the steps of:
providing a display interface operatively coupled to the electronic tuner, the display interface having a plurality of separately illuminatable light emitting devices situated in a continuous, closed loop arrangement;
illuminating a first light emitting device of the continuous, closed loop arrangement of light emitting devices to correspond to a reference musical note in response to a played note on the musical instrument, the first light emitting device being illuminated in a first color; and
illuminating a second light emitting device of the continuous, closed loop arrangement of light emitting devices which is different from the first light emitting device in response to the played note, the second light emitting device being illuminated in a second color which is different from the first color, the relative angular distance between the second light emitting device and the first light emitting device being proportional to the intonation of the played note with respect to the reference musical note.

8. A method as defined by claim 7, wherein the step of illuminating the second light emitting device includes the further step of illuminating the second light emitting device at a position which is one of counter-clockwise of the first light emitting device and clockwise of the first light emitting device, wherein a counter-clockwise position of the illuminated second light emitting device relative to the first light emitting device indicates to the user that the played note is one of flat and sharp, and wherein a clockwise position of the illuminated second light emitting device relative to the first light emitting device indicates to the user that the played note is the other of flat and sharp.

9. A method as defined by claim 8, which further comprises the step of:
de-illuminating the second light emitting device when the frequency of the played note is substantially equal to the frequency of the reference musical note to indicate to the user that the musical instrument is in tune with respect to the played note.

10. A method as defined by claim 7, wherein the step of illuminating the second light emitting device includes the further steps of pulse width modulating the illumination of the second light emitting device to partially illuminate the second light emitting device, and pulse width modulating the illumination of a third light emitting device of the continuous, closed loop arrangement of light emitting devices to partially illuminate the third light emitting device, the third light emitting device being different from the first light emitting device and the second light emitting device, the third light emitting device being situated adjacent to the second light emitting device and being partially illuminated in the second color.

11. A method of displaying to a user of an electronic tuner for a musical instrument whether a played note is in tune and the intonation of the played note with respect to a reference musical note, which comprises the steps of:
providing a display interface operatively coupled to the electronic tuner, the display interface having a plurality of separately illuminatable light emitting devices situated in a continuous, closed loop arrangement;
illuminating a first light emitting device of the continuous, closed loop arrangement of light emitting devices to correspond to a reference musical note in response to a played note on the musical instrument, the first light emitting device being illuminated in a first color; and
sequentially illuminating light emitting devices of the continuous, closed loop arrangement of light emitting devices other than the first light emitting device in a second color different from the first color in response to the played note and in a first rotational direction if the played note is flat with respect to the reference musical note and in a second rotational direction opposite to the first rotational direction if the played note is sharp with respect to the reference musical note.

12. A method as defined by claim 11, wherein the step of sequentially illuminating light emitting devices further includes the step of sequentially illuminating the light emitting devices other than the first light emitting device at an angular velocity which varies proportionally to the intonation of the played note with respect to the reference musical note.

13. A method as defined by claim 12, wherein the angular velocity of the sequential illumination of the light emitting devices of the continuous, closed loop arrangement of light emitting devices other than the first light emitting device is relatively higher with a relatively greater intonation of the played note with respect to the reference musical note, and is relatively lower with a relatively smaller intonation of the played note with respect to the reference musical note.

14. A method as defined by claim 12, wherein the angular velocity of the sequential illumination of the light emitting devices of the continuous, closed loop arrangement of light emitting devices other than the first light emitting device is zero when the frequency of the played note is substantially equal to the frequency of the reference musical note to indicate to the user that the musical instrument is in tune with respect to the played note.

15. An electronic tuner for tuning a musical instrument, which comprises:
a display interface, the display interface including:
a plurality of spaced apart, separately illuminatable light emitting devices situated in a continuous circular array;
a cylindrically-shaped light pipe, the light pipe having radially extending slits formed therein to define individually illuminatable segments, the light pipe being situated in proximity to the circular array of light emitting devices, wherein each segment of the light pipe is illuminatable by a respective light emitting device; and
a disc-shaped note dial, the note dial being situated in proximity to the light pipe, the note dial having illuminatable indicia on a surface thereof corresponding to musical notes, the indicia being illuminatable by the light pipe for viewing by a user of the electronic tuner; and
a microcontroller, the microcontroller being operatively coupled to the display interface and selectively illuminating the light emitting devices.

16. An electronic tuner for tuning a musical instrument, which comprises:
a display interface, the display interface including:
a plurality of separately illuminatable light emitting devices;
a cylindrically-shaped light pipe, the light pipe having a plurality of individually illuminatable segments arranged in a continuous circular array, each segment being optically coupled to a respective light emitting device and being illuminatable thereby; and
individually illuminatable indicia corresponding to musical notes disposed in a circular arrangement, the indicia being optically coupled to respective segments of the light pipe and being illuminatable thereby for viewing by a user of the electronic tuner; and
a microcontroller, the microcontroller being operatively coupled to the display interface and selectively illuminating the light emitting devices.

17. A display interface for an electronic tuner for tuning a musical instrument, which comprises:
a plurality of spaced apart, separately illuminatable light emitting devices situated in a continuous, closed loop arrangement.

18. A display interface for an electronic tuner for tuning a musical instrument, which comprises:
a plurality of spaced apart, separately illuminatable light emitting devices situated in a continuous, closed loop arrangement; and
a display cover, the display cover having an outer wall and an inner wall spaced apart from the outer wall, and a plurality of spaced apart dividing walls extending transversely between the outer wall and the inner wall, the outer and inner walls and the plurality of dividing walls defining therebetween a continuous arrangement of display cover segments, each of the display cover segments being aligned with a corresponding one of the light emitting devices of the continuous, closed loop arrangement of light emitting devices and at least partially receiving therein the corresponding one of the light emitting devices.

19. A display interface for an electronic tuner as defined by claim 18, which further comprises:
a light diffuser, the light diffuser being in optical communication with each segment of the display cover and each light emitting device of the continuous, closed loop arrangement of light emitting devices.

20. A display interface for an electronic tuner as defined by claim 18, which further comprises:
a lens, the lens being formed of a light transmissible material and being positioned in optical communication with the segments of the display cover.

21. A display interface for an electronic tuner for tuning a musical instrument, which comprises:
a plurality of spaced apart, separately illuminatable light emitting devices situated in a continuous, closed loop arrangement;
a display cover, the display cover having an outer wall and an inner wall spaced apart from the outer wall, and a plurality of spaced apart dividing walls extending transversely between the outer wall and the inner wall, the outer and inner walls and the plurality of dividing walls defining therebetween a continuous arrangement of display cover segments, each of the display cover segments being aligned with a corresponding one of the light emitting devices and having a first open end to at least partially receive therethrough the corresponding one of the light emitting devices; and
a light diffuser, the light diffuser being in optical communication with each segment of the display cover and each light emitting device of the continuous, closed loop arrangement of light emitting devices.

22. A display interface for an electronic tuner as defined by claim 21, wherein the light diffuser is formed as an optical resin received by each segment of the display cover.

23. A display interface for an electronic tuner as defined by claim 21, wherein each segment of the display cover includes a second open end disposed opposite the first open end; and wherein the light diffuser is formed as an optical resin received by each segment of the display cover through the second open end thereof.

24. A display interface for an electronic tuner as defined by claim 21, which further comprises:
a lens, the lens being formed of a light transmissible material and being positioned in optical communication with the segments of the display cover.

25. A display interface for an electronic tuner for tuning a musical instrument, which comprises:
a plurality of spaced apart, separately illuminatable light emitting devices situated in a continuous, closed loop arrangement; and
a plurality of segmented elements, each segmented element corresponding to a respective one of the light emitting devices of the continuous, closed loop arrangement of light emitting devices and being selectively illuminatable thereby.

26. An electronic tuner for tuning a musical instrument, which comprises:
a display interface, the display interface including:
a plurality of spaced apart, separately illuminatable light emitting devices situated in a continuous, closed loop arrangement; and
a microcontroller, the microcontroller being operatively coupled to the display interface and selectively illuminating the light emitting devices.

27. An electronic tuner for tuning a musical instrument, which comprises:
a display interface, the display interface including:
a plurality of spaced apart, separately illuminatable light emitting devices situated in a continuous, closed loop arrangement; and
a display cover, the display cover having an outer wall and an inner wall spaced apart from the outer wall, and a plurality of spaced apart dividing walls extending transversely between the outer wall and the inner wall, the outer and inner walls and the plurality of dividing walls defining therebetween a continuous arrangement of display cover segments, each of the display cover segments being aligned with a corresponding one of the light emitting devices of the continuous, closed loop arrangement of light emitting devices and at least partially receiving therein the corresponding one of the light emitting devices; and
a microcontroller, the microcontroller being operatively coupled to the display interface and selectively illuminating the light emitting devices.

28. A method of displaying to a user of an electronic tuner for a musical instrument whether a played note is in tune and the intonation of the played note with respect to a reference musical note, which comprises the steps of:
providing a display interface operatively coupled to the electronic tuner, the display interface having a plurality of separately illuminatable light emitting devices situated in a continuous, closed loop arrangement and structure defining a reference point;
illuminating a first selected light emitting device of the continuous, closed loop arrangement of light emitting devices in response to the played note, the relative angular distance between the first selected light emitting device and the reference point defining structure being proportional to the intonation of the played note with respect to the reference musical note.

29. A method as defined by claim 28, wherein the structure defining a reference point includes an illuminatable light emitting device which is different from the first selected light emitting device.

30. A method as defined by claim 28, wherein the step of illuminating the first selected light emitting device includes the further step of illuminating the first selected light emitting device at a position which is one of counter-clockwise of the reference point defining structure and clockwise of the reference point defining structure, wherein a counter-clockwise position of the illuminated first selected light emitting device relative to the reference point defining structure indicates to the user that the played note is one of flat and sharp, and wherein a clockwise position of the illuminated first selected light emitting device relative to the reference point defining structure indicates to the user that the played note is the other of flat and sharp.

31. A method as defined by claim 30, which further comprises the step of:
de-illuminating the first selected light emitting device when the frequency of the played note is substantially equal to the frequency of the reference musical note to indicate to the user that the musical instrument is in tune with respect to the played note.

32. A method as defined by claim 31, which further comprises the step of:
illuminating a predetermined light emitting device which is different from the first selected light emitting device when the frequency of the played note is substantially equal to the frequency of the reference musical note to indicate to the user that the musical instrument is in tune with respect to the played note.

33. A method as defined by claim 32, wherein the step of illuminating the first selected light emitting device further includes the step of illuminating the first selected light emitting device in a first color; and wherein the step of illuminating the predetermined light emitting device which is different from the first selected light emitting device includes the step of illuminating the predetermined light emitting device in a second color which is different from the first color.

34. A method as defined by claim 28, wherein the step of illuminating the first selected light emitting device includes the further steps of pulse width modulating the illumination of the first selected light emitting device to partially illuminate the first selected light emitting device, and pulse width modulating the illumination of a second selected light emitting device of the continuous, closed loop arrangement of light emitting devices to partially illuminate the second selected light emitting device, the second selected light emitting device being different from the first selected light emitting device, the second selected light emitting device being situated adjacent to the first selected light emitting device.

35. A method of displaying to a user of an electronic tuner for a musical instrument whether a played note is in tune and the intonation of the played note with respect to a reference musical note, which comprises the steps of:
providing a display interface operatively coupled to the electronic tuner, the display interface having a plurality of separately illuminatable light emitting devices situated in a continuous, closed loop arrangement and structure defining a reference point;
sequentially illuminating light emitting devices of the continuous, closed loop arrangement of light emitting devices in response to the played note and in a first rotational direction if the played note is flat with respect to the reference musical note and in a second rotational direction opposite to the first rotational direction if the played note is sharp with respect to the reference musical note.

36. A method as defined by claim 35, wherein the step of sequentially illuminating light emitting devices further includes the step of sequentially illuminating the light emitting devices at an angular velocity which varies proportionally to the intonation of the played note with respect to the reference musical note.

37. A method as defined by claim 36, wherein the angular velocity of the sequential illumination of the light emitting devices of the continuous, closed loop arrangement of light emitting devices is relatively higher with a relatively greater intonation of the played note with respect to the reference musical note, and is relatively lower with a relatively smaller intonation of the played note with respect to the reference musical note.

38. A method as defined by claim 36, wherein the angular velocity of the sequential illumination of the light emitting devices of the continuous, closed loop arrangement of light emitting devices is zero when the frequency of the played note is substantially equal to the frequency of the reference musical note to indicate to the user that the musical instrument is in tune with respect to the played note.
